(19) United States
(12) Patent Application Publication
(10) Pub. No.: US 2026/0362450 A1
(43) Pub. Date: Nov. 12, 2026

(54) COMBINING DOWNLINK CONTROL INFORMATION (DCI) FOR ACCURATE PAYLOAD DECODING

(71) Applicant: QUALCOMM Incorporated, San Diego, CA (US)

(72) Inventors: Lior UZIEL, Hod Hasharon (IL); Peer BERGER, Hod Hasharon (IL); Tal OVED, Modiin (IL)

(21) Appl. No.: 19/205,985

(22) Filed: May 12, 2025

(51) Int. Cl. H04W 72/232; H04W 72/044

(52) U.S. Cl. CPC H04W 72/232; H04W 72/044

(57) ABSTRACT

This disclosure provides methods, components, devices and systems for combining downlink control information (DCI) for accurate payload decoding. A user equipment (UE) may receive control signaling that indicates a set of resources to receive a first DCI message and a retransmission of the first DCI message, along with mapping information that indicates a second set of bit fields included within the retransmission that are unchanged relative to a first set of bit fields included within the first DCI message. The UE may receive the first DCI message, and may store a first set of log-likelihood ratios (LLRs) of the first set of bit fields of the first DCI message. The UE may receive the retransmission of the first DCI message and may decode the DCI payload by combining the first set of LLRs with a second set of LLRs associated with the second set of bit fields of the retransmission.

### TECHNICAL FIELD

This disclosure relates generally to wireless communication, and more specifically to systems, devices, methods, and techniques associated with combining downlink control information (DCI) for accurate payload decoding.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a UE is described. The method may include receiving control signaling that indicates a set of resources allocated for reception of one or more downlink control information (DCI) messages including at least a first DCI message and a retransmission of the first DCI message, and mapping information indicating a second set of bit fields included within the retransmission of the first DCI message that are unchanged relative to a first set of bit fields included within the first DCI message as originally transmitted, receiving the first DCI message via the set of resources, storing, in a memory of the UE, a first set of log-likelihood ratios (LLRs) associated with the first set of bit fields of the first DCI message, receiving, via the set of resources, the retransmission of the first DCI message that includes the second set of bit fields that are unchanged relative to the first set of bit fields included in the first DCI message, and decoding a payload of the first DCI message and the retransmission of the first DCI message based on combining, in accordance with the mapping information, the first set of LLRs associated with the first set of bit fields of first DCI message with a second set of LLRs associated with the second set of bit fields of the retransmission of the first DCI message.

A UE for wireless communications is described. The UE may include a processing system that includes processor circuitry and memory circuitry that stores code. The processing system may be configured to cause the UE to receive control signaling that indicates a set of resources allocated for reception of one or more DCI messages including at least a first DCI message and a retransmission of the first DCI message, and mapping information indicating a second set of bit fields included within the retransmission of the first DCI message that are unchanged relative to a first set of bit fields included within the first DCI message as originally transmitted, receive the first DCI message via the set of resources, store, in a memory of the UE, a first set of LLRs associated with the first set of bit fields of the first DCI message, receive, via the set of resources, the retransmission of the first DCI message that includes the second set of bit fields that are unchanged relative to the first set of bit fields included in the first DCI message, and decode a payload of the first DCI message and the retransmission of the first DCI message based on combining, in accordance with the mapping information, the first set of LLRs associated with the first set of bit fields of first DCI message with a second set of LLRs associated with the second set of bit fields of the retransmission of the first DCI message.

Another UE for wireless communications is described. The UE may include means for receiving control signaling that indicates a set of resources allocated for reception of one or more DCI messages including at least a first DCI message and a retransmission of the first DCI message, and mapping information indicating a second set of bit fields included within the retransmission of the first DCI message that are unchanged relative to a first set of bit fields included within the first DCI message as originally transmitted, means for receiving the first DCI message via the set of resources, means for storing, in a memory of the UE, a first set of LLRs associated with the first set of bit fields of the first DCI message, means for receiving, via the set of resources, the retransmission of the first DCI message that includes the second set of bit fields that are unchanged relative to the first set of bit fields included in the first DCI message, and means for decoding a payload of the first DCI message and the retransmission of the first DCI message based on combining, in accordance with the mapping information, the first set of LLRs associated with the first set of bit fields of first DCI message with a second set of LLRs associated with the second set of bit fields of the retransmission of the first DCI message.

A non-transitory computer-readable medium storing code for wireless communications is described. The code may include instructions executable by one or more processors to receive control signaling that indicates a set of resources allocated for reception of one or more DCI messages including at least a first DCI message and a retransmission of the first DCI message, and mapping information indicating a second set of bit fields included within the retransmission of the first DCI message that are unchanged relative to a first set of bit fields included within the first DCI message as originally transmitted, receive the first DCI message via the set of resources, store, in a memory of the UE, a first set of LLRs associated with the first set of bit fields of the first DCI message, receive, via the set of resources, the retransmission of the first DCI message that includes the second set of bit fields that are unchanged relative to the first set of bit fields included in the first DCI message, and decode a payload of the first DCI message and the retransmission of the first DCI message based on combining, in accordance with the mapping information, the first set of LLRs associated with the first set of bit fields of first DCI message with a second set of LLRs associated with the second set of bit fields of the retransmission of the first DCI message.

Some examples of the method, UEs, and non-transitory computer-readable medium described herein may further include operations, features, means, or instructions for receiving, via the control signaling, additional control signaling, or both, a timing relationship for receiving the retransmission of the first DCI message relative to the first DCI message in a same downlink channel allocation, where combining the first set of LLRs and the second set of LLRs may be based on receiving the retransmission of the first DCI message in accordance with the timing relationship.

In some examples of the method, UEs, and non-transitory computer-readable medium described herein, the first DCI message includes a first DCI identifier and the retransmission of the first DCI message includes a second DCI identifier that may be incremented relative to the first DCI identifier and combining the first set of LLRs and the second set of LLRs may be based on the first DCI identifier and the second DCI identifier.

In some examples of the method, UEs, and non-transitory computer-readable medium described herein, the retransmission of the first DCI message includes a pointer to a resource allocation associated with transmission of the first DCI message and combining the first set of LLRs with the second set of LLRs may be based on the pointer.

In some examples of the method, UEs, and non-transitory computer-readable medium described herein, the control signaling that indicates the set of resources allocated for reception of the first DCI message includes a pointer to a resource allocation associated with the retransmission of the first DCI message.

Some examples of the method, UEs, and non-transitory computer-readable medium described herein may further include operations, features, means, or instructions for transmitting one or more UE capability messages including an indication that the UE supports LLR combining, an indication of storage capabilities at the UE, an indication of whether the UE supports systematic polar decoding, or any combination thereof, where receiving the control signaling may be based on transmitting the one or more UE capability messages.

In some examples of the method, UEs, and non-transitory computer-readable medium described herein, the storage capabilities of the UE include an indication of a quantity of LLRs the UE may be capable of storing, an amount of information included in a quantity of slots that the UE may be capable of storing, a quantity of DCIs for which the UE may be able to store LLRs, a quantity of control channel elements (CCEs) for which the UE may be able to store LLRs, or any combination thereof.

Some examples of the method, UEs, and non-transitory computer-readable medium described herein may further include operations, features, means, or instructions for transmitting, to a network entity, an indication of a failure to decode the first DCI message, where receiving the retransmission of the first DCI message may be based on transmitting the indication of the failure.

In some examples of the method, UEs, and non-transitory computer-readable medium described herein, the retransmission of the first DCI message includes a third set of bit fields that may be changed relative to corresponding bit fields of the first DCI message, the third set of bit fields including one or more indicator fields that may be either incremented relative to corresponding indicator fields of the first DCI message or indicated as being unchanged relative to the corresponding indicator fields of the first DCI message and the UE refrains from combining LLRs associated with the one or more indicator fields based on the third set of bit fields being changed or being indicated as being unchanged relative to corresponding bit fields of the first DCI message.

In some examples of the method, UEs, and non-transitory computer-readable medium described herein, the one or more indicator fields include at least one of a downlink assignment index (DAI) field, a null data indicator (NDI) field, a frequency domain resource allocation (FDRA) field, or a time domain resource allocation (TDRA) field.

In some examples of the method, UEs, and non-transitory computer-readable medium described herein, the first DCI message and the retransmission of the first DCI message may be encoded in accordance with a systematic encoding of the first set of bit fields and the second set of bit fields.

In some examples of the method, UEs, and non-transitory computer-readable medium described herein, the first set of bit fields of the first DCI message include at least a subset of the payload of the first DCI message, the second set of bit fields include at least a subset of the payload of the retransmission of the first DCI message, and the first DCI message and the retransmission of the first DCI message may be included in different quantities of control channel elements and may be associated with different downlink control channel allocations.

In some examples of the method, UEs, and non-transitory computer-readable medium described herein, the first DCI message may be received in accordance with a first aggregation level configuration associated with a first quantity of CCEs of a first set of resource element groups (REGs) for conveying the first DCI message and the retransmission of the first DCI message may be received in accordance with a second aggregation level configuration that corresponds to one or more repetitions of the first aggregation level configuration, the second aggregation level configuration associated with a second quantity of CCEs of a second set of REGs for conveying the retransmission of the first DCI message.

Some examples of the method, UEs, and non-transitory computer-readable medium described herein may further include operations, features, means, or instructions for combining the first set of LLRs corresponding to the first set of CCEs associated with the first aggregation level configuration of the first DCI message with the second set of LLRs corresponding to the second set of CCEs associated with the second aggregation level configuration of the retransmission of the first DCI message.

Some examples of the method, UEs, and non-transitory computer-readable medium described herein may further include operations, features, means, or instructions for transmitting an indication of a DCI detection type supported for LLR combining, where decoding the payload may be based on the first DCI message and the retransmission of the first DCI message including the DCI detection type, and where the DCI detection type includes a non-blind decoded DCI, a DCI candidate located in a common search space, a DCI candidate located in a UE-specific search space, or any combination thereof.

In some examples of the method, UEs, and non-transitory computer-readable medium described herein, the mapping information includes a bitmap that indicates, using respective binary values, individual bits included in the second set of bit fields that may be changed or unchanged relative to the first set of bit fields, or an indication that the first set of bit fields and the second set of bit fields include a set of unchanged bit values for both the first DCI message and the retransmission of the first DCI message.

In some examples of the method, UEs, and non-transitory computer-readable medium described herein, the first set of LLRs and the second set of LLRs include a matching set of LLRs and the second set of bit fields included within the retransmission of the first DCI message include a second set of bits that may be unchanged relative to a first set of bits of the first set of bit fields included within the first DCI message as originally transmitted.

A method for wireless communications by a network entity is described. The method may include outputting control signaling that indicates a set of resources allocated for one or more DCI messages including at least a first DCI message and a retransmission of the first DCI message, and mapping information indicating a second set of bit fields included within the retransmission of the first DCI message that are unchanged relative to a first set of bit fields included within the first DCI message as originally transmitted, outputting the first DCI message via the set of resources, outputting, via the set of resources, the retransmission of the first DCI message that includes the second set of bit fields that are unchanged relative to the first set of bit fields included in the first DCI message, and communicating with a UE in accordance with a payload of the first DCI message and the retransmission of the first DCI message.

A network entity for wireless communications is described. The network entity may include a processing system that includes processor circuitry and memory circuitry that stores code. The processing system may be configured to cause the network entity to output control signaling that indicates a set of resources allocated for one or more DCI messages including at least a first DCI message and a retransmission of the first DCI message, and mapping information indicating a second set of bit fields included within the retransmission of the first DCI message that are unchanged relative to a first set of bit fields included within the first DCI message as originally transmitted, output the first DCI message via the set of resources, output, via the set of resources, the retransmission of the first DCI message that includes the second set of bit fields that are unchanged relative to the first set of bit fields included in the first DCI message, and communicate with a UE in accordance with a payload of the first DCI message and the retransmission of the first DCI message.

Another network entity for wireless communications is described. The network entity may include means for outputting control signaling that indicates a set of resources allocated for one or more DCI messages including at least a first DCI message and a retransmission of the first DCI message, and mapping information indicating a second set of bit fields included within the retransmission of the first DCI message that are unchanged relative to a first set of bit fields included within the first DCI message as originally transmitted, means for outputting the first DCI message via the set of resources, means for outputting, via the set of resources, the retransmission of the first DCI message that includes the second set of bit fields that are unchanged relative to the first set of bit fields included in the first DCI message, and means for communicating with a UE in accordance with a payload of the first DCI message and the retransmission of the first DCI message.

A non-transitory computer-readable medium storing code for wireless communications is described. The code may include instructions executable by one or more processors to output control signaling that indicates a set of resources allocated for one or more DCI messages including at least a first DCI message and a retransmission of the first DCI message, and mapping information indicating a second set of bit fields included within the retransmission of the first DCI message that are unchanged relative to a first set of bit fields included within the first DCI message as originally transmitted, output the first DCI message via the set of resources, output, via the set of resources, the retransmission of the first DCI message that includes the second set of bit fields that are unchanged relative to the first set of bit fields included in the first DCI message, and communicate with a UE in accordance with a payload of the first DCI message and the retransmission of the first DCI message.

Some examples of the method, network entities, and non-transitory computer-readable medium described herein may further include operations, features, means, or instructions for encoding the first DCI message and the retransmission of the first DCI message in accordance with a systematic encoding of the first set of bit fields and the second set of bit fields, where outputting the first DCI message and the retransmission of the first DCI message may be based on the systematic encoding.

### BRIEF DESCRIPTION OF THE DRAWINGS

FIG. 1 shows an example of a wireless communication system.

FIG. 2 shows an example of a signaling configuration that supports combining downlink control information (DCI) for accurate payload decoding.

FIG. 3 shows an example of a DCI combining scheme that supports combining DCI for accurate payload decoding.

FIG. 4 shows an example of an aggregation level configuration that supports combining DCI for accurate payload decoding.

FIG. 5 shows an example of a process flow that supports combining DCI for accurate payload decoding.

FIG. 6 shows a block diagram of a processing system that supports combining DCI for accurate payload decoding.

FIG. 7 shows a diagram of a system including a device that supports combining DCI for accurate payload decoding.

FIG. 8 shows a block diagram of a processing system that supports combining DCI for accurate payload decoding.

FIG. 9 shows a diagram of a system including a device that supports combining DCI for accurate payload decoding.

FIGS. 10 and 11 show flowcharts illustrating methods that support combining DCI for accurate payload decoding.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, a network entity may support techniques to notify a user equipment (UE) of an allocated resource (e.g., one or more time and frequency resources) to expect a transmission of downlink control information (DCI). That is, the network entity may “unveil” a specific or allocated location of the DCI to the UE, so that the UE has knowledge of where to expect the DCI. Such techniques of unveiling a resource location of a to-be-transmitted DCI may reduce blind decoding errors by the UE, and increase power savings for the UE, by enabling the UE to perform fewer DCI detection processes and blind decodes. In addition, if the UE has prior knowledge as to a set of allocated resources to receive the DCI, the UE may also be able to accurately determine when the DCI is missed (e.g., when the UE fails to decode or mis-detects the DCI). In other cases, when the UE receives a DCI but is not able to completely or successfully decode all the bits of the DCI, the UE may be unable to save any information regarding the originally transmitted DCI, such as log-likelihood ratios (LLRs) of the originally transmitted DCI, that would help the UE accurately identify and receive future retransmissions of the same DCI.

Aspects of the subject matter described in this disclosure relate to techniques for efficient handling of retransmissions of DCI when the UE is aware of an originally mis-detected DCI. For example, if the UE expects a DCI in a first resource location (e.g., a first set of time and/or frequency resources), the UE may store information regarding the mis-detected DCI, such as a set of LLRs associated with different bit fields of the DCI. For the purpose of the present disclosure, LLRs may refer to some statistical metric or measurement that indicated a relative likelihood (e.g., probability) that a given bit field includes a certain value (e.g., relative likelihood that a bit field includes a “1” instead of a “0,” or relative likelihood that a symbol including more than one bit includes a respective value). For the purposes of the present disclosure, the term “bit field,” “field,” and like terms, may be used to refer to a known (e.g., preconfigured) set of bits inside the DCI payload (e.g., bits 4-7), or can relate to a known field in the payload (e.g., FDRA field).

The UE may then receive a retransmission of the DCI, and may combine matching LLRs of the retransmission with the LLRs of the originally transmitted DCI in order to gain enough information to accurately decode the DCI payload.

To support accurate combination of LLRs, the network entity may encode the DCI and retransmissions of the DCI using systematic coding or systematic polar coding (e.g., rather than or in addition to polar coding), which may allow the UE to systematically match bit fields of the originally transmitted DCI and the retransmission in order to combine LLRs. In such cases, the DCI payload may remain the same between the originally-transmitted DCI and the DCI retransmission (e.g., same information, same ordering of bit fields, same bit field values, etc.) so that the LLRs may be combined across the original DCI and DCI retransmission. For example, bit fields that would otherwise be incremented or flipped (such as downlink assignment index (DAI) or new data indicator (NDI) bit fields) may remain the same (e.g., not incremented or flipped) between the original DCI and DCI retransmission. Stated differently, the information and bit fields within the DCI retransmission may essentially be “frozen” relative to the originally-transmitted DCI. Additionally, or alternatively, the network entity and the UE may support different aggregation levels for transmission of the DCI and the retransmission of the DCI, so that matching bit fields (and therefore LLRs corresponding to the matching bit fields) may be identified and combined.

In addition, the UE may utilize capability signaling to indicate support for LLR combination, specific DCI detection types in which LLR combination is supported, along with support for systematic decoding of DCI transmissions. The network entity may support signaling that indicates resource allocations for retransmissions of a missed DCI, indications of original DCIs and retransmissions of DCIs to combine, added DCI identifiers that may be incremented such that the UE is aware of the missed DCI (e.g., if a DCI identifier is skipped), among other signaling.

Particular aspects of the subject matter described in this disclosure can be implemented to realize one or more of the following potential advantages. In some examples, by allowing the UE to store information regarding a previously mis-detected DCI, the described techniques may enable UEs to use the stored information to improve the likelihood/probability that a retransmission of DCI will be successfully received/decoded. For example, after the UE mis-detects a DCI transmission, the UE may store LLRs of the DCI in on-device memory, and may combine matching LLRs of a retransmission of the DCI in order to identify and decode the DCI payload. Additionally, or alternatively, the techniques described herein may allow for reduced blind decoding errors, because the UE may be able to identify specific resource locations to monitor for DCI transmissions and retransmissions. The techniques described herein may also allow for reduced control signaling overhead. For example, the network entity may transmit relatively fewer retransmissions of a DCI because the UE may use previously stored information such as LLRs to help decode a first retransmission. Moreover, because DCI messages may include accompanying data (e.g., PDSCH data, PUSCH data), techniques described herein which reduce the quantity or number of DCI retransmissions not only reduce control signaling overhead, but also reduce network traffic for communicating data (e.g., PDSCH data, PUSCH data).

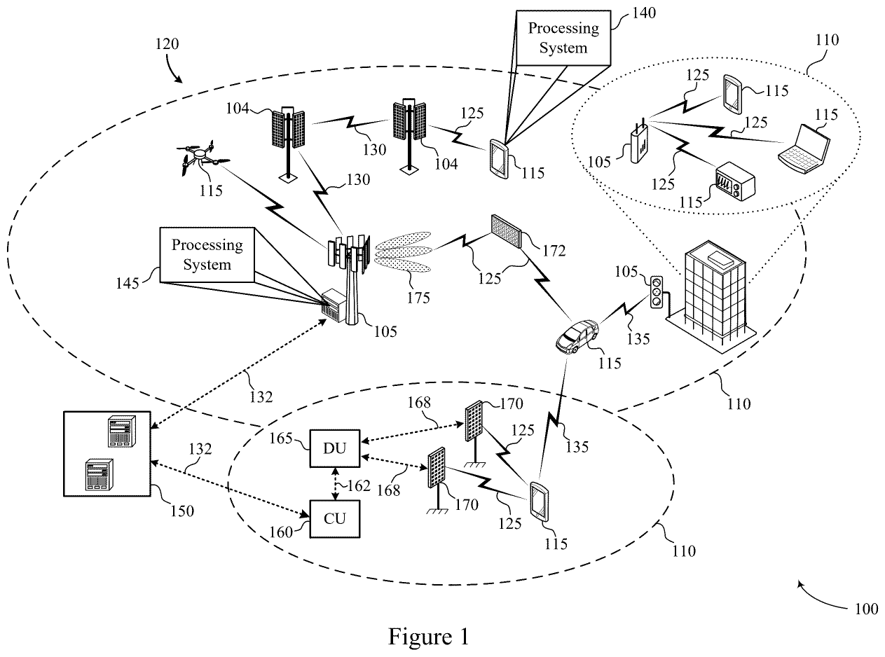

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHZ), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating DCI and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for combining DCI for accurate payload decoding. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support techniques for efficient handling of retransmissions of DCI when the UE 115 is aware of an originally mis-detected DCI.

For example, if the UE 115 expects a DCI in a first resource location (e.g., a first set of time and/or frequency resources), the UE 115 may store information regarding the mis-detected DCI, such as a set of LLRs associated with different bit fields of the DCI. The UE 115 may then receive a retransmission of the DCI, and may combine matching LLRs of the retransmission with the LLRs of the originally transmitted DCI in order to gain enough information to accurately decode the DCI payload. To support accurate combination of LLRs, the network entity 105 may encode the DCI and retransmissions of the DCI using systematic coding or systematic polar coding (e.g., rather than or in addition to polar coding), which may allow the UE to systematically match bit fields of the originally transmitted DCI and the retransmission in order to combine LLRs of matching bit fields. In such cases, the DCI payload may remain the same between the originally-transmitted DCI and the DCI retransmission (e.g., same information, same ordering of bit fields, same bit fields value, etc.) so that the LLRs may be combined across the original DCI and DCI retransmission. For example, bit fields that would otherwise be incremented or flipped (such as downlink assignment index (DAI) or new data indicator (NDI) bit fields) may remain the same (e.g., not incremented or flipped) between the original DCI and DCI retransmission. Stated differently, the information and bit fields within the DCI retransmission may essentially be “frozen” relative to the originally-transmitted DCI. Additionally, or alternatively, the network entity 105 and the UE 115 may support different aggregation levels for transmission of the DCI and the retransmission of the DCI, so that matching LLRs may be identified and combined. The techniques described herein may allow for improved DCI and PDCCH detection accuracy, reduced control signaling overhead, and improved device coordination.

For example, the network entity 105 may transmit relatively fewer retransmissions of a DCI because the UE 115 may use previously stored information such as LLRs to help decode a first retransmission. Moreover, because DCI messages may include accompanying data (e.g., PDSCH data, PUSCH data), techniques described herein which reduce the quantity or number of DCI retransmissions not only reduce control signaling overhead, but also reduce network traffic for communicating data (e.g., PDSCH data, PUSCH data).

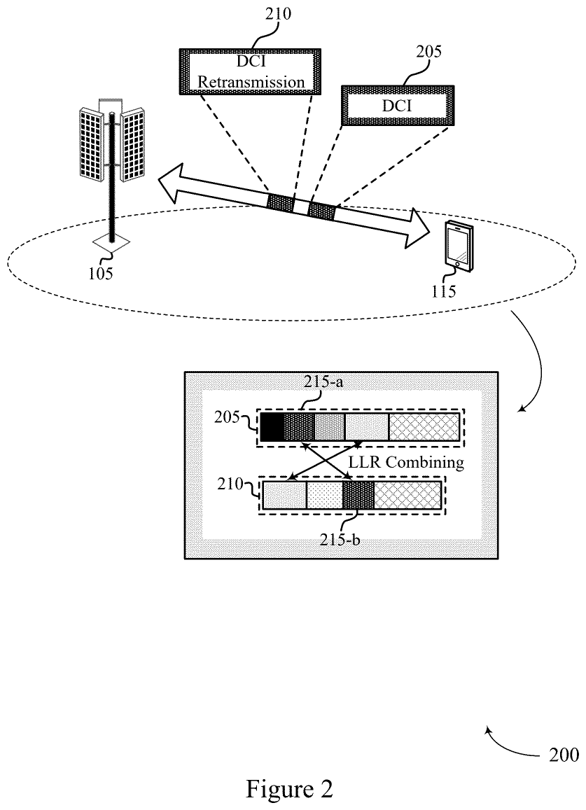

FIG. 2 shows an example of a signaling configuration 200 that supports combining DCI for accurate payload decoding. For example, the signaling configuration 200 may support communications between a UE 115 and a network entity 105, each of which may be examples of corresponding UEs 115 and network entities 105 described with reference to FIG. 1. In some aspects, the UE 115 and the network entity 105 may support techniques for LLR storage and LLR combining for accurate DCI detection and decoding.

The network entity 105 may implement techniques to notify the UE 115 of resources (e.g., time and frequency resources) to expect a transmission of a DCI 205. That is, the network entity 105 may “unveil” or otherwise indicate a resource location of the DCI 205 to the UE 115 prior to transmission of the DCI 205 (e.g., using previously unicast DCI or in group common DCI), so that the UE 115 has knowledge of the resource location where to expect the DCI 205. Such unveiling techniques may reduce blind decoding errors by the UE 115, because the UE 115 may perform less blind searching and blind decoding in order to receive the DCI 205. In addition, fewer blind decodes may also allow for increased power savings since the UE 115 has to perform relatively fewer search space monitoring and decoding operations. In addition, if the UE 115 has knowledge of the resources to receive the DCI 205, the UE 115 may be able to accurately determine when the DCI 205 is missed (e.g., mis-detected).

In such cases, because the UE 115 had prior knowledge of the DCI 205 that was mis-detected, the UE 115 may also have access to additional information about the DCI 205. For example, the UE 115 may identify or otherwise “know” the payload size of the DCI 205 (e.g., K), which may be known at the UE 115 due to the “unveiling” of the existence of the DCI 205, as described herein (as the payload size is needed in order to blind-decode the DCI 205, and is based on the RRC configuration and other sources of information. Additionally, the UE 115 may identify the format of the DCI 205 (e.g., DCI format x_0 or DCI format x_1), a backoff and/or non-backoff configuration, or any combination thereof. In addition, the UE 115 may have knowledge of the resource candidate of the DCI 205, including the aggregation level (e.g., N, which may be 2ⁿ=32/64/128/256/512/1024), along with a quantity of symbols allocated for the DCI 205 (e.g., E=108/216/432/864/1728). In some cases, the UE 115 may store information of the mis-detected DCI (such as LLRs of the mis-detected DCI) for future use.

In some cases, the network entity 105 may be aware of the failed decoding of the DCI 205. For example, the network entity may fail to receive HARQ-ACK from the UE 115 (e.g., a non-detected PUCCH resource or discontinuous transmission from the UE 115). Additionally, or alternatively, the UE 115 may notify the network entity 105 of the missed DCI using an uplink transmission via a preconfigured PUCCH resource to implicitly indicate failure of PDCCH reception (versus to aforementioned HARQ-ACK for PDSCH, which implicitly indicate a failure to receive the DCI due to non energy). In response to the mis-detected DCI, the network entity 105 may transmit a retransmission of the DCI (e.g., a DCI retransmission 210), and the UE 115 may combine the LLRs of the DCI 205 (e.g., the mis-detected DCI) with corresponding LLRs of the DCI retransmission 210 in order to accurately decode the information from the DCI 205.

For example, since the UE 115 knows the location of the expected DCI, the UE 115 may store information regarding the mis-detected DCI such as LLRs associated with different bit fields of the DCI 205. The UE 115 may then receive the DCI retransmission 210, and may combine matching LLRs of the retransmission with the LLRs of the originally transmitted DCI in order to gain enough information to accurately decode the DCI payload. For instance, the UE 115 may determine that a bit field 215-b within the DCI retransmission 210 corresponds to and is identical to (e.g., is unchanged relative to) a bit field 215-a within the DCI 205. In other words, the bit fields 215-a, 215-b may indicate the same data payload (e.g., same bit value, or same bits of a symbol for symbols including more than one bit, such as QPSK symbols containing multiple bits). As such, the UE 115 may combine an LLR associated with the bit field 215-b of the DCI retransmission 210 with an LLR associated with the bit field 215-a of the DCI 205 in order to improve a probability or likelihood that the data payload of the bit fields 215-a, 15-b may be accurately decoded.

The UE 115 and the network entity 105 may support additional or alternative techniques to enable accurate DCI decoding. For example, the network entity 105 may use systematic coding (or systematic polar coding) in place of polar coding to encode the payload of the DCI, which may allow for the UE 115 to identify portions of the payload from the DCI 205 and the DCI retransmission 210 that are systematically mapped to the same bit fields, which may allow the UE 115 to identify the LLRs to combine for the DCI 205 and the DCI retransmission 210. In addition, the network entity 105 and the UE 115 may support different types of aggregation levels (e.g., “aggregation level-B,” where the “B” refers to a second manner of describing aggregation levels that is different from “aggregation level-2” (AL2), as described in further detail herein) for transmission of the DCI and the retransmission of the DCI, which may allow for more accurate decoding of the DCI payload. In addition, the UE 115 may utilize capability signaling to indicate support for LLR combination, specific DCI detection types in which LLR combination is supported, along with support for systematic decoding. The network entity 105 may support signaling that indicates resource allocations for retransmissions of a missed DCI, and/or added DCI identifiers that may be incremented (or indicated to stay the same) such that the UE 115 is aware of the missed DCI (e.g., if a DCI identifier is skipped).

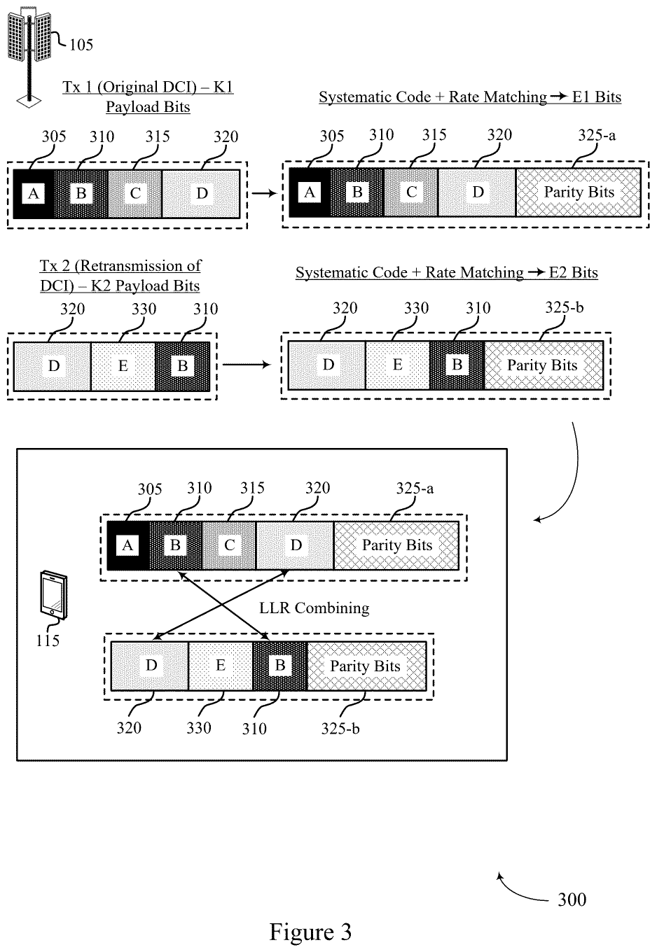

FIG. 3 shows an example of a DCI combining scheme 300 that supports combining DCI for accurate payload decoding. For example, the DCI combining scheme 300 may support DCI transmissions and DCI retransmissions communicated between a UE 115 and a network entity 105, each of which may be examples of corresponding devices described with reference to FIGS. 1 and 2.

In some cases, the network entity 105 may notify or configure the UE 115 with a set of resources to expect a transmission of DCI. In such cases, the network entity 105 may “unveil” a resource location of the DCI to the UE 115, so that the UE 115 may have access to additional information of where to expect the DCI, and will have more complete knowledge as to when the UE 115 misses (e.g., mis-detects) the DCI. In some aspects, in order to increase DCI detection and decoding accuracy, the UE 115 may support techniques to save information regarding the originally missed DCI, such as LLRs of the DCI, which may be potentially helpful to use for receiving retransmissions. That is, the UE 115 may combine LLRs of an originally transmitted (and mis-detected) DCI with LLRs of one or more retransmissions of the originally transmitted DCI in order to correctly decode the information (e.g., control payload) included in the DCI (e.g., the UE 115 may enter LLRs from both the originally transmitted DCI and the one or more retransmissions of the DCI into the decoder for LLR combining). In some examples, the receiver of the UE 115 may be capable of storing LLRs of a received PDCCH (e.g., the originally transmitted DCI, a first retransmission of the DCI), and combine the LLRs from the received PDCCH with matching LLRs of a new transmission (e.g., a retransmission of the DCI).

In some examples, the one or more retransmissions of the DCI may share a same DCI payload as the originally transmitted DCI (e.g., having the same K payload bits or identical bits of the DCI payload), the same transmitted CCEs (e.g., having the same N CCEs), the same PDCCH allocation (e.g., having the same E). In such examples, the UE 115 may combine all of the LLRs obtained from the original transmission of the DCI and the one or more retransmissions of the DCI in order to correctly decode the DCI payload. In some implementations, the UE 115 may combine LLRs from the originally transmitted DCI and multiple (e.g., two or more, up to three) retransmissions. For example, the UE 115 may receive the original DCI and a first retransmission of the DCI and may mis-detect both the original DCI and the first retransmission of the DCI. The UE 115 may receive a second retransmission (and, optionally a third retransmission, a fourth retransmission, etc.), and may combine LLRs of the one or more retransmissions in order to correctly decode the original DCI.

In some cases, if the UE 115 fails to decode the original DCI (or one or more retransmissions of the DCI) that was previously indicated or “unveiled” by the network entity 105, the UE 115 may transmit one or more messages to indicate the misdetection. Based on the indication provided by the UE 115, the network entity 105 may transmit the same DCI again to the UE 115. In such cases, the UE 115 may ignore incrementing fields such as a downlink assignment index (DAI) field, a null data indicator (NDI) field, a frequency domain resource allocation (FDRA) field, or a time domain resource allocation (TDRA) field, or any combination thereof. For example, such fields in the DCI may, in some cases, indicate a new DCI transmission from the network entity 105, but because the UE 115 had previously requested the retransmission of the original DCI, the UE 115 may know to ignore any incrementing fields that indicate a potentially new DCI transmission. In such cases, the UE 115 may ignore the last missed DCI, and may treat the retransmitted DCI as the originally transmitted DCI.

In some other cases, the network entity 105 may indicate, to the UE 115, that the incrementing fields will not be incremented (e.g., the fields may stay the same between the initial transmission of the DCI and the retransmission of the DCI). In yet other cases, fields that would otherwise be incremented or flipped (such as DAI fields, NDI fields, etc.) may simply be removed or otherwise omitted from the DCI payload of the DCI retransmissions (e.g., DAI may not be needed in case of non-blind decoded operation where the DCIs are “unveiled”). Stated differently, the transmitter may “freeze” the information and bit fields across the originally-transmitted DCI and DCI retransmission (e.g., information and bit fields within the DCI retransmission may essentially be “frozen” relative to the originally-transmitted DCI).

In some PDCCH communications, however, a UE 115 may be unable to combine LLRs in cases where there is no direct mapping between K payload bits of the DCI to encoded bits. In order to combine LLRs from different transmissions, aspects of the present disclosure are directed to techniques for LLR matching, where LLRs with the same encoded or non-encoded bits may be combined across different transmissions. For example, instead of encoding the DCI bits using a polar encoding, the network entity 105 may use a systematic encoding (or any other systematic encoder and/or precoder, such as a systematic polar encoder), where the network entity 105 may encode certain bits of the DCI payload (e.g., K bits) using a systematic encoding. In such examples, the DCIs that the network entity 105 transmits may have at least partially the same K (e.g., the DCI payload may include several unchanging fields, which may be statically or dynamically configured, such as FDRA fields), with different transmitted CCEs (e.g., different N CCEs), and/or a different PDCCH allocation (e.g., different E). That is, the payload of the DCI and the one or more retransmissions of the DCI may be different, but at least some of the fields are the same (e.g., the fields may be the same in content, but may or may not be the same in position).

For example, the network entity 105 may encode a first DCI transmission having a first set of fields, such as a first field 305, a second field 310, a third field 315, and a fourth field 320, which together may include a first quantity of DCI payload bits (e.g., K₁ payload bits). The network entity 105 may encode the DCI payload bits using a systematic encoding and may perform rate matching to produce a second set of encoded fields, including systematically encoded and rate matched versions of the first field 305, the second field 310, the third field 315, and the fourth field 320, which together may include a corresponding quantity of rate matched bits (e.g., E₁ rate matched bits). The network entity 105 may also add a quantity of parity bits 325-a (K₁ parity bits) as part of the systematic encoding, where the E₁ rate matched bits may include the parity bits.

The network entity 105 may encode one or more retransmissions of the first DCI transmission. The retransmission of the first DCI transmission may include one or more sets of DCI payload bits, which may at least partially match one or more of the fields of the first DCI transmission as originally transmitted. For example, the retransmission of the first DCI transmission may include the fourth field 320, a fifth field 330, and the second field 310, which together may include a second quantity of DCI payload bits (e.g., K₂ payload bits). As noted herein, for the purposes of the present disclosure, the term “bit field,” “field,” and like terms, may be used to refer to a known (e.g., preconfigured) set of bits inside the DCI payload (e.g., bits 4-7), or can relate to a known field in the payload (e.g., FDRA field). The network entity 105 may encode the DCI payload bits using a systematic encoding and may perform rate matching to produce a second set of encoded fields, including systematically encoded and rate matched versions of the fourth field 320, a fifth field 330, and the second field 310, which together may include a corresponding quantity of rate matched bits (e.g., E₂ rate matched bits, which may include added parity bits). The network entity 105 may also add a quantity of parity bits 325-b (E₂-K₂ parity bits) as part of the systematic encoding.

After receiving the first DCI transmission and the retransmission of the first DCI transmission, the UE 115 may combine LLRs of identical fields from the first DCI transmission and the retransmission of the first DCI transmission (e.g., the UE 115 may combine all LLRs that are mapped systematically to the same fields of the first DCI transmission and the retransmission of the first DCI transmission, or otherwise, the fields that are a subset of K that are the same). For example, the UE 115 may combine LLRs from the second field 310 included in both the first DCI transmission and the retransmission of the first DCI transmission, and may combine fields of the fourth field 320 from the first DCI transmission and the retransmission of the first DCI transmission. Using the combined LLRs, the UE may attempt to decode the first DCI transmission as originally transmitted, the retransmission of the first DCI transmission, or both.

The UE 115 may support different techniques in order to enable LLR combining for different DCI transmissions. For example, the UE 115 may indicate, using UE capability signaling (or via UE capability negotiation) an indication of whether the UE 115 supports LLR combining. For example, the UE capability signaling may include an indication of a storage capability of the UE 115 (e.g., how much on-device storage the UE 115 has available for storing LLRs), what types of communications LLR storage may be applied for (e.g., whether LLR storage is only used for PDCCH), total storage capability for different types of communications (e.g., storage capability for storing LLRs for PDSCH and/or PDCCH), whether the UE 115 supports systematic polar decoding, systematic decoding, or other decoder types. The UE capability signaling may additionally, or alternatively, indicate a total quantity of transmissions for which the UE 115 may store LLRs. For example, the UE 115 may indicate the storage available at the UE 115 by reporting an explicit quantity such as the total quantity of LLRs supported, an implicit indication by reporting a quantity of slots, DCIs, or CCEs that are to be stored.

Additionally, or alternatively, the UE 115 may indicate or identify one or more DCI detection types that that are to be LLR combined (e.g., the UE 115 may determine in which scenarios or DCI detections that the UE 115 will combine LLRs). For example, the UE 115 may be configured to LLR combine DCIs that are non-blind decoded DCIs, or otherwise DCIs whose location was pre-notified to the UE 115. Additionally, or alternatively, the UE 115 may be configured to perform LLR combining for entire candidates in a common search space, candidates in a UE-specific search spaces SS, or both. In some cases, the UE 115 may have access to enough resources to store blind decoded DCIs and non-blind decoded DCIs.

In some cases, the UE 115 may support a systematic decoder, and the network entity 105 may indicate (e.g., via RRC signaling, MAC-CE, or other control signaling) which payload bits of the retransmission of the first DCI transmission are unchanged relative to the first DCI transmission as originally transmitted. In other words, the network entity 105 may transmit control signaling to the UE 115, where the control signaling includes mapping information that indicates a second set of bit fields (e.g., bit fields 310, 310) included within the retransmission of the first DCI transmission that are unchanged relative to a first set of bit fields (e.g., bit fields 310, 310) included within the first DCI transmission as originally transmitted. That is, in the example shown in FIG. 3, the mapping information may indicate that bit fields D and B are unchanged (e.g., identical) across both the first DCI transmission and the retransmission of the first DCI transmission.

For example, the network entity 105 may indicate unchanging bits in the DCI payload using a bitmap of size K, where a bit value of 1 in the bitmap indicates a changed payload bit, and a bit value of 0 indicates an unchanged payload bit. Additionally, or alternatively, the network entity 105 may indicate unchanging fields as being static fields (e.g., fields that are statically unchanging for transmissions of the DCI) or semi static (e.g., the network entity 105 may indicate unchanging or changing fields using RRC signaling, such as changing or unchanging FDRA fields). For example, the network entity may indicate that a field (such as an FDRA field) containing six bits as being the same for a retransmission, instead of individually indicating bits two through seven for the field.

In some implementations, the UE 115 may receive information regarding LLRs from which DCIs are to be combined together. For example, the UE 115 may be configured with a rule indicating that a retransmission of an original DCI may occur on same PDCCH allocation after K slots, so that if the UE 115 receives a first DCI transmission and then receives a retransmission of the first DCI transmission after K slots, the UE 115 may combine LLRs from the first DCI transmission and the retransmission of the first DCI transmission accordingly. In some examples, the UE 115 may receive signaling that includes an indication of the retransmission (e.g., the indication may identify the retransmission as occurring after n slots within a same PDCCH allocation).

In some examples, the network entity 105 may add a DCI identifier (i.e., DCI_{ID}) to one or more parameters that are used to “unveil” or indicate the DCI locations to the UE 115. For example, the DCI identifier may indicate resources in which the UE 115 may receive an initial transmission of the first DCI transmission as well as one or more retransmissions of the first DCI transmission, so that the UE 115 may know to combine LLRs from the indicated DCIs. In some aspects, the DCI_{ID} may be the same as a HARQ process ID for the respective PDSCH and/or PUSCH that it schedules. In some examples, the indication may include information of a to-be detected DCI as well as the resource allocation of a DCI that is to be combined with the to-be detected DCI. In some examples, the network entity 105 may add a pointer (e.g., an indication) to the allocation of a retransmitted DCI (in addition to the indication of the PDCCH allocation) which may allow for the UE 115 to identify a past transmitted DCI to combine with the retransmission of the DCI.

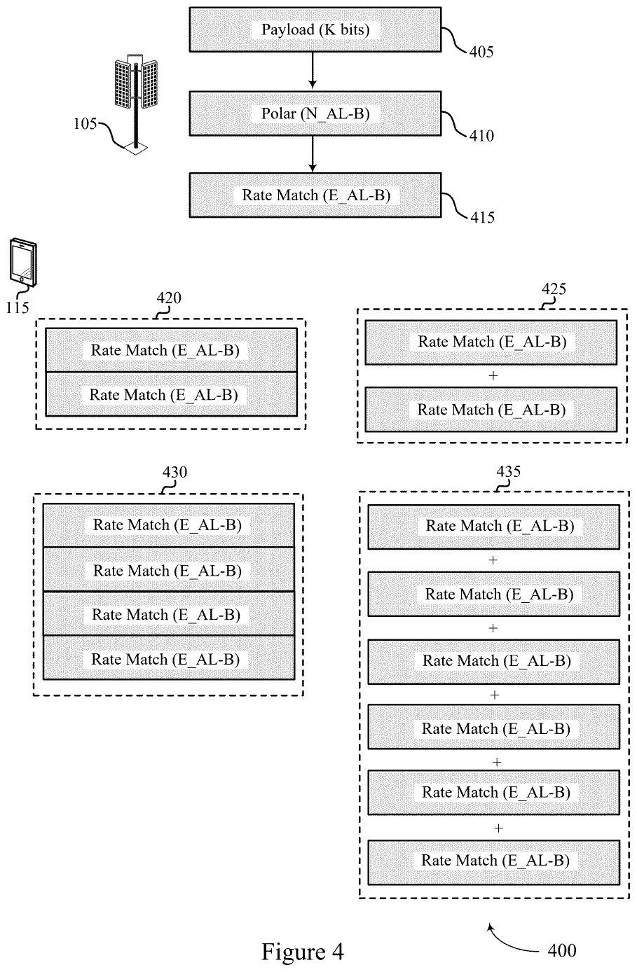

FIG. 4 shows an example of an aggregation level configuration 400 that supports combining DCI for accurate payload decoding. For example, the aggregation level configuration 400 may support DCI transmissions and DCI retransmissions communicated between a UE 115 and a network entity 105, each of which may be examples of corresponding devices described herein.

As described herein, aspects of the present disclosure may support different types of aggregation levels (e.g., different from aggregation level 1, aggregation level 2, etc.). Conventional aggregation levels (e.g., aggregation level 1, aggregation level 2, etc.) refer to the number of CCEs over which a message (DCI) will be transmitted. For example, with aggregation level 1, a single CCE is used for transmitting a DCI message.

In contrast, and in accordance with aspects of the present disclosure, the UE 115 may support DCI combining using one or more aggregation levels, which may indicate that the DCI payload bits (e.g., K payload bits), the same transmitted CCEs (e.g., N CCEs), and PDCCH allocation (e.g., E) are mapped to the same CCE across transmissions, so that the UE 115 may know to combine the LLRs from the initial DCI and the one or more retransmissions of the DCI. For example, the UE 115 and the network entity 105 may support a new type of aggregation level, “Aggregation Level-B” (e.g., “AL-B”), which supports duplicating the REGs (e.g., by increasing N and E by the factor of the aggregation level change), and may be a second manner to describe an existing aggregation level. For example, the UE 115 may support various different aggregation levels (e.g., AL1, AL2, AL4, AL8, AL16), and the aggregation level B operation (e.g., second aggregation level configuration) may be used to describe a second manner of applying different existing aggregation levels (e.g., ALB-1, ALB-2, ALB-4, ALB-8, ALB-16).

To support “AL-B” operation, the initial DCI and the one or more retransmissions of the DCI may share the same K (DCI payload), the same N (CCEs) and the same E (PDCCH allocation) in each CCE, duplicated in several CCEs (equal to a number of the aggregation level). In such cases, the aggregation level may allow for replication even in cases of puncturing and/or shortening of the PDCCH. In such cases, the UE 115 may combine all LLRs mapped to same resource elements between the CCEs in the transmission and retransmission, based on the aggregation level.

For example, the network entity 105 may obtain a quantity of DCI payload bits 405 (e.g., K DCI payload bits), and may encode the bits using a polar encoding 410 (or any other kind of encoding) in accordance with the aggregation level B for N CCEs. The network entity 105 may then perform rate matching 415 in accordance with the aggregation level B for the PDCCH allocation E. The network entity 105 may duplicate the aggregation level B bits, and the UE 115 may combine each of the E_AL-B bits (which are identical) prior to decoding the K DCI payload bits.

For example, the first DCI transmission 420 may be configured with an aggregation level 4 by applying two times an aggregation level 2 (in accordance with the aggregation level B), which may result in two repetitions of the rate matched bits. The UE 115 may perform LLR combining 425 at a first reception opportunity for the first DCI transmission. In some cases, the decoding may fail, and the network entity may transmit a second transmission of the DCI, and may increase the aggregation level 2 bits to increase the robustness of the DCI transmission. For example, the second DCI transmission 430 may be an aggregation level 8 transmission obtained by applying two times an aggregation level 4 (in accordance with the aggregation level B), which may result in four repetitions of the rate matched bits. The UE 115 may perform LLR combining 435 at a second reception opportunity for the second DCI transmission 430, and may combine LLRs from the initial LLR combining 425 and the LLR combining 435 (e.g., combining LLRs from six total repetitions of the rate matched bits). In some cases, the combining of the LLRs from both transmissions of the DCI may allow for successful and accurate decoding of the DCI.

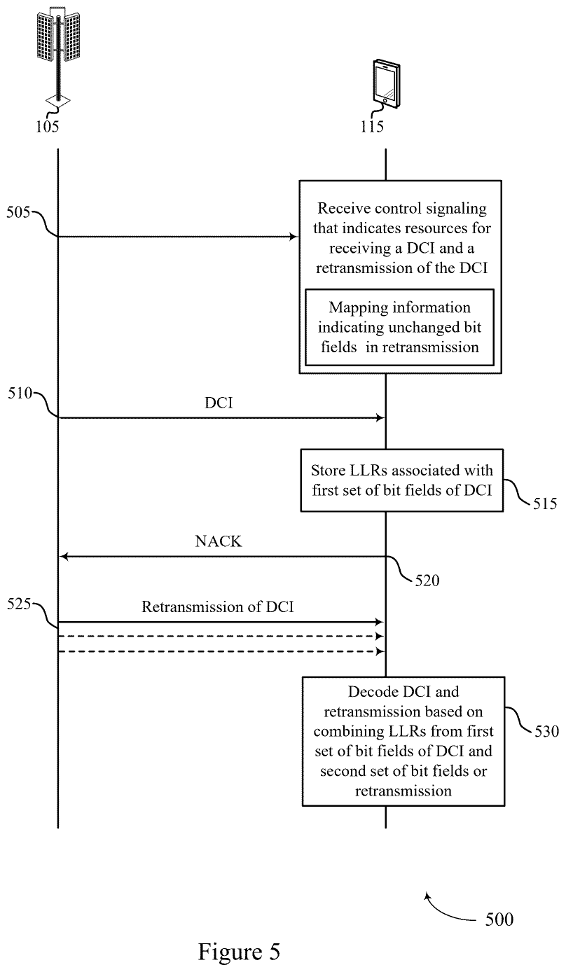

FIG. 5 shows an example of a process flow 500 that supports combining DCI accurate payload decoding. For example, the process flow 500 may support communications between a UE 115 and a network entity 105, each of which may be examples of corresponding devices described herein. In some aspects, the network entity 105, the UE 115, or both, may support DCI unveiling techniques, DCI resource indication techniques, LLR combining, or any combination thereof as described herein.

Alternative examples of the following may be implemented. Some steps are performed in a different order than described or are not performed at all. In some implementations, steps may include additional features not mentioned below, or additional steps may be added. Further, although the UE 115 and the network entity 105 are shown performing the operations of the process flow 500, some aspects of some operations may also be performed by one or more other wireless communication devices (such as by multiple network entities, multiple UEs).

At signaling operation 505, the UE 115 may receive, from the network entity 105, control signaling (e.g., one or more RRC messages, one or more MAC-CEs, or both) that indicates a set of resources allocated for reception of one or more DCI messages comprising at least a first DCI message (such as the DCI 205), and a retransmission of the first DCI message (e.g., the DCI retransmission 210, where a retransmission of the first DCI message may include one or more individual retransmissions of the first DCI message). In some examples, the control signaling may include mapping information that indicates a second set of bit fields included within the retransmission of the first DCI message that are unchanged relative to a first set of bit fields included within the first DCI message as originally transmitted. For example, the mapping information may include a bitmap that indicates, using respective binary values, individual bits included in the second set of bit fields that are changed or unchanged relative to the first set of bit fields. Additionally, or alternatively, the mapping information may include an indication that the first set of bit fields and the second set of bit fields include a set of unchanged bit values for both the first DCI message and the retransmission of the first DCI message.

At signaling operation 510, the network entity 105 may transmit, and the UE 115 may receive, the first DCI (e.g., the DCI 205) via the set of resources.

At storage operation 515, the UE 115 may store (e.g., in on-device memory) a first set of LLRs associated with the first set of bit fields of the first DCI message (e.g., a first field 305, a second field 310, a third field 315, and a fourth field 320). In some examples, the UE 115 may transmit, to the network entity 105, an indication of a failure to decode the first DCI message.

At signaling operation 520, the UE 115 may transmit a message (e.g., NACK) to the network entity 105 to indicate that the UE 115 failed to successfully receive and/or decode all the bits/symbols of the DCI at signaling operation 510 (to trigger a DCI retransmission, as described herein).

At signaling operation 525, the network entity 105 may transmit, and the UE 115 may receive, via the set of resources, the retransmission of the first DCI message (e.g., the DCI retransmission 210) that includes the second set of bit fields (e.g., the fourth field 320 and the second field 310) that are unchanged relative to the first set of bit fields included in the first DCI message. In some examples, the network entity 105 may transmit the retransmission of the first DCI message based on receiving an indication of decoding failure of the first DCI from the UE 115. In some examples, the network entity 105 may encode the first DCI message and the retransmission of the first DCI message using a systematic encoding of the first set of bit fields and the second set of bit fields.

At decoding operation 530, the UE 115 may decode a payload of the first DCI message and the retransmission of the first DCI message by combining, in accordance with the mapping information, the first set of LLRs associated with the first set of bit fields of first DCI message with a second set of LLRs associated with the second set of bit fields of the retransmission of the first DCI message. In some examples, the first set of LLRs and the second set of LLRs are a matching set of LLRs, and the second set of bit fields included within the retransmission of the first DCI message include a second set of bits that are unchanged relative to a first set of bits of the first set of bit fields included within the first DCI message as originally transmitted. In the case where the retransmission of DCI is not linked to a specific CCE allocation of the first-missed DCI (at signaling operation 510), but rather indicates resources that contain several possible DCIs (part of the entire blind decoding), and if the UE 115 is able to store LLRs of all the possible hypothesis of DCIs, then the decoding is done with each LLRs stored. In other words, in cases where the UE 115 does not know which originally-transmitted DCI that the retransmission corresponds to, the UE 115 may attempt to combine the LLRs of the retransmission with LLRs of multiple previously mis-detected DCI messages (e.g., UE 115 attempts to combine LLRs of the retransmission at signaling operation 525 with stored LLRs of the original DCI at signaling operation 510, as well as with LLRs of other previously-received DCI messages).

In some examples, the UE 115 may receive (e.g., via the control signaling, additional control signaling, or both) a timing relationship for receiving the retransmission of the first DCI message relative to the first DCI message in a same downlink channel allocation (e.g., a same PDCCH allocation). In some such examples, the UE 115 may combine the first set of LLRs and the second set of LLRs based on receiving the retransmission of the first DCI message in accordance with the timing relationship. In some examples, the first DCI message may include a first DCI identifier and the retransmission of the first DCI message may include a second DCI identifier that is incremented relative to the first DCI identifier. In some such examples, the UE 115 may combine the first set of LLRs and the second set of LLRs based on the first DCI identifier and the second DCI identifier. In some examples, the retransmission of the first DCI message may include a pointer to a resource allocation associated with transmission of the first DCI message, and the UE 115 may combine the first set of LLRs with the second set of LLRs based on the pointer (e.g., the UE 115 may determine the first DCI to combine with the retransmission based on the pointer identifying the first DCI as the initial transmission). Additionally, or alternatively, the control signaling that indicates the set of resources allocated for reception of the first DCI message also may include a pointer to a resource allocation associated with the retransmission of the first DCI message (e.g., the UE 115 may identify the retransmission of the first DCI to combine with the first DCI based on the pointer).

In some examples, the UE 115 may transmit one or more UE capability messages that include an indication that the UE 115 supports LLR combining, an indication of storage capabilities at the UE 115, an indication of whether the UE 115 supports systematic polar decoding, or any combination thereof. For example, the storage capabilities of the UE 115 may include an indication of a quantity of LLRs the UE 115 is capable of storing, an amount of information included in a quantity of slots that the UE 115 is capable of storing, a quantity of DCIs for which the UE 115 is able to store LLRs, a quantity of CCEs for which the UE 115 is able to store LLRs, or any combination thereof.

In some examples, the retransmission of the first DCI message may include a third set of bit fields that are changed relative to corresponding bit fields of the first DCI message. For example, the third set of bit fields may include one or more indicator fields that are either incremented relative to corresponding indicator fields of the first DCI message (e.g., a DAI field, a NDI field, an FDRA field, a TDRA field) or indicated as being unchanged relative to the corresponding indicator fields of the first DCI message. In such examples, the UE 115 may refrain from combining LLRs associated with the one or more indicator fields based on the third set of bit fields being changed or being indicated as being unchanged relative to corresponding bit fields of the first DCI message.

In some examples, the first DCI message and the retransmission of the first DCI message may be encoded using a systematic encoding (e.g., a systematic polar encoding) of the first set of bit fields and the second set of bit fields. In some such examples, the first set of bit fields of the first DCI message may include at least a subset of the payload of the first DCI message, the second set of bit fields may include at least a subset of the payload of the retransmission of the first DCI message, and the first DCI message and the retransmission of the first DCI message may be included in different quantities of control channel elements and may be associated with different downlink control channel allocations.

In some examples, the UE 115 may receive the first DCI using a first aggregation level configuration (e.g., the aggregation level configurations described with reference to FIG. 4) associated with a first quantity of CCEs of a first set of REGs for conveying the first DCI message. The UE 115 may receive the retransmission of the first DCI message using a second aggregation level configuration that corresponds to one or more repetitions of the first aggregation level configuration. In some such examples, the second aggregation level configuration may be with a second quantity of CCEs of a second set of REGs for conveying the retransmission of the first DCI message. In some cases, the UE 115 may combine the first set of LLRs corresponding to the first set of CCEs associated with the first aggregation level configuration of the first DCI message with the second set of LLRs corresponding to the second set of CCEs associated with the second aggregation level configuration of the retransmission of the first DCI message.

In some examples, the UE 115 may transmit, to the network entity 105, an indication of a DCI detection type that the UE 115 supports for LLR combining. In some such examples, the DCI detection type may include a non-blind decoded DCI, a DCI candidate located in a common search space, a DCI candidate located in a UE-specific search space, or any combination thereof.

As described herein, the UE 115 may only be able to identify missed DCIs for DCI's that are “unveiled” (e.g., scheduled on previously-configured resources). In this regard, the UE 115 may not store LLRs for DCIs that are not “unveiled.” For example, in an alternative implementation, the first DCI at signaling operation 510 may not be “unveiled,” meaning that the UE 115 does not have a prior indication of the resources over which the DCI at signaling operation 510 will be communicated. As such, the UE 115 may not store LLRs associated with the DCI at signaling operation 510. Subsequently, the network may schedule the retransmission of the DCI at signaling operation 525, thereby “unveiling” the retransmission of the DCI. As such, the UE 115 may begin to store LLRs starting from the retransmission of the DCI at signaling operation 510. In other words, LLRs may be stored only after mis-detecting an indicted (unveiled) DCI, either for original or retransmitted DCIs.

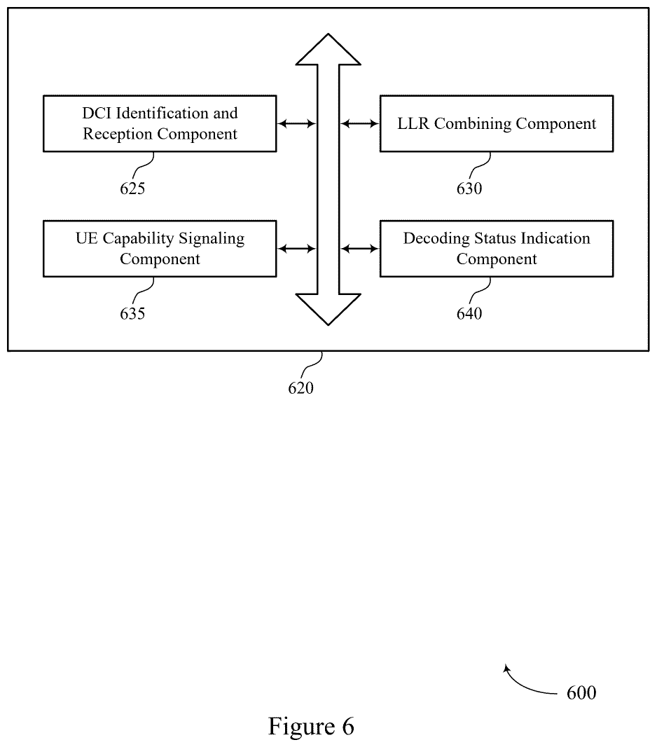

FIG. 6 shows an example 600 of a processing system 620 that supports combining DCI for accurate payload decoding. A processing system 620 may be an example of a processing system 140 (such as of a UE 115) and may include a DCI identification and reception component 625, an LLR combining component 630, a UE capability signaling component 635, a decoding status indication component 640, or any combination thereof. A processing system 620, or various component thereof, may be an example of means for performing (such as a means for causing a UE 115 to perform) various techniques described herein.

The DCI identification and reception component 625 may be configured to cause the UE 115 to receive control signaling that indicates a set of resources allocated for reception of one or more DCI messages including at least a first DCI message and a retransmission of the first DCI message, and mapping information indicating a second set of bit fields included within the retransmission of the first DCI message that are unchanged relative to a first set of bit fields included within the first DCI message as originally transmitted. In some examples, the DCI identification and reception component 625 may be configured to cause the UE 115 to receive the first DCI message via the set of resources. The LLR combining component 630 may be configured to cause the UE 115 to store, in a memory of the UE, a first set of LLRs associated with the first set of bit fields of the first DCI message. In some examples, the DCI identification and reception component 625 may be configured to cause the UE 115 to receive, via the set of resources, the retransmission of the first DCI message that includes the second set of bit fields that are unchanged relative to the first set of bit fields included in the first DCI message. In some examples, the LLR combining component 630 may be configured to cause the UE 115 to decode a payload of the first DCI message and the retransmission of the first DCI message based on combining, in accordance with the mapping information, the first set of LLRs associated with the first set of bit fields of first DCI message with a second set of LLRs associated with the second set of bit fields of the retransmission of the first DCI message.

In some examples, the DCI identification and reception component 625 may be configured to cause the UE 115 to receive, via the control signaling, additional control signaling, or both, a timing relationship for receiving the retransmission of the first DCI message relative to the first DCI message in a same downlink channel allocation, where combining the first set of LLRs and the second set of LLRs is based on receiving the retransmission of the first DCI message in accordance with the timing relationship.

In some examples, the first DCI message includes a first DCI identifier, and the retransmission of the first DCI message includes a second DCI identifier that is incremented relative to the first DCI identifier. In some examples, combining the first set of LLRs and the second set of LLRs is based on the first DCI identifier and the second DCI identifier. In some examples, the retransmission of the first DCI message includes a pointer to a resource allocation associated with transmission of the first DCI message. In some examples, combining the first set of LLRs with the second set of LLRs is based on the pointer. In some examples, the control signaling that indicates the set of resources allocated for reception of the first DCI message includes a pointer to a resource allocation associated with the retransmission of the first DCI message.

In some examples, the UE capability signaling component 635 may be configured to cause the UE 115 to transmit one or more UE capability messages including an indication that the UE supports LLR combining, an indication of storage capabilities at the UE, an indication of whether the UE supports systematic polar decoding, or any combination thereof, where receiving the control signaling is based on transmitting the one or more UE capability messages.

In some examples, the storage capabilities of the UE include an indication of a quantity of LLRs the UE is capable of storing, an amount of information included in a quantity of slots that the UE is capable of storing, a quantity of DCIs for which the UE is able to store LLRs, a quantity of control channel elements (CCEs) for which the UE is able to store LLRs, or any combination thereof.

In some examples, the decoding status indication component 640 may be configured to cause the UE 115 to transmit, to a network entity, an indication of a failure to decode the first DCI message, where receiving the retransmission of the first DCI message is based on transmitting the indication of the failure.

In some examples, the retransmission of the first DCI message includes a third set of bit fields that are changed relative to corresponding bit fields of the first DCI message, the third set of bit fields including one or more indicator fields that are either incremented relative to corresponding indicator fields of the first DCI message or indicated as being unchanged relative to the corresponding indicator fields of the first DCI message. In some examples, the UE refrains from combining LLRs associated with the one or more indicator fields based on the third set of bit fields being changed or being indicated as being unchanged relative to corresponding bit fields of the first DCI message.

In some examples, the one or more indicator fields include at least one of a downlink assignment index (DAI) field, a null data indicator (NDI) field, a frequency domain resource allocation (FDRA) field, or a time domain resource allocation (TDRA) field. In some examples, the first DCI message and the retransmission of the first DCI message are encoded in accordance with a systematic encoding of the first set of bit fields and the second set of bit fields.

In some examples, the first set of bit fields of the first DCI message include at least a subset of the payload of the first DCI message. In some examples, the second set of bit fields include at least a subset of the payload of the retransmission of the first DCI message. In some examples, the first DCI message and the retransmission of the first DCI message are included in different quantities of control channel elements and are associated with different downlink control channel allocations. In some examples, the systematic encoding includes a systematic polar encoding.

In some examples, the first DCI message is received in accordance with a first aggregation level configuration associated with a first quantity of control channel elements (CCEs) of a first set of resource element groups (REGs) for conveying the first DCI message. In some examples, the retransmission of the first DCI message is received in accordance with a second aggregation level configuration that corresponds to one or more repetitions of the first aggregation level configuration, the second aggregation level configuration associated with a second quantity of CCEs of a second set of REGs for conveying the retransmission of the first DCI message.

In some examples, the LLR combining component 630 may be configured to cause the UE 115 to combine the first set of LLRs corresponding to the first set of CCEs associated with the first aggregation level configuration of the first DCI message with the second set of LLRs corresponding to the second set of CCEs associated with the second aggregation level configuration of the retransmission of the first DCI message.

In some examples, the UE capability signaling component 635 may be configured to cause the UE 115 to transmit an indication of a DCI detection type supported for LLR combining, where decoding the payload is based on the first DCI message and the retransmission of the first DCI message including the DCI detection type, and where the DCI detection type includes a non-blind decoded DCI, a DCI candidate located in a common search space, a DCI candidate located in a UE-specific search space, or any combination thereof. In some examples, the control signaling includes one or more RRC messages, one or more MAC-CEs, or both.

In some examples, the mapping information includes a bitmap that indicates, using respective binary values, individual bits included in the second set of bit fields that are changed or unchanged relative to the first set of bit fields, or an indication that the first set of bit fields and the second set of bit fields include a set of unchanged bit values for both the first DCI message and the retransmission of the first DCI message.

In some examples, the first set of LLRs and the second set of LLRs include a matching set of LLRs. In some examples, the second set of bit fields included within the retransmission of the first DCI message include a second set of bits that are unchanged relative to a first set of bits of the first set of bit fields included within the first DCI message as originally transmitted.

A processing system 620 may include or be a component of one or more chips, systems-on-chips (SoCs), chipsets, packages, components, or devices that individually or collectively constitute or include a processing system. A processing system 620 may interface with other components of a processing system 620. For example, operations described with reference to a processing system 620, or various components thereof, may be performed by or with other such components, including a receiver, a transmitter, a transceiver, a modem, a user interface, a modulator/demodulator, an encoder/decoder, or any combination thereof (such as of the processing system 620, coupled with the processing system 620, of a processing system 620).

By including or configuring a processing system 620 for operation in a processing system 620 as described herein, the processing system 620 may support techniques for improved communication reliability, reduced blind decoding and DCI decoding latency, reduced power consumption due to fewer failed blind decoding attempts, more efficient utilization of communication resources, improved coordination between devices, longer battery life, improved accuracy for DCI decoding, and reduced control signaling overhead.

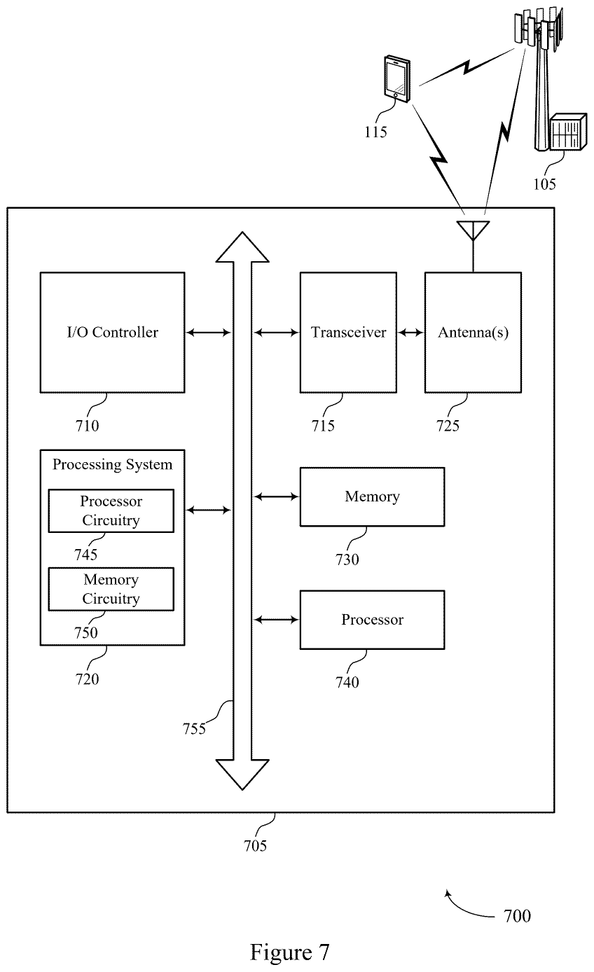

FIG. 7 shows an example of a system 700 including a device 705 that supports combining DCI for accurate payload decoding. The device 705 may be an example of or include components of UE 115. The device 705 may communicate (such as wirelessly) with one or more other devices (such as network entities 105, UEs 115). The device 705 may include components for transmitting and receiving communication, which may include a processing system 720, an input/output (I/O) controller, such as an I/O controller 710, a transceiver 715, antenna(s) 725, a memory 730, and a processor 740. Components of the device 705 may be coupled (such as operatively, communicatively, functionally, electronically, electrically, in electronic communication) a bus 755.

The transceiver 715 may support bi-directional communication via antenna(s) 725, and may support transmission operations, reception operations, or both, as described herein. The transceiver 715 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 705). The transceiver 715 may modulate symbols and provide the modulated symbols to antenna(s) 725 for transmission, and demodulate symbols from signals received using antenna(s) 725.

The processor 740 may be a general-purpose processing component that supports various operations (such as applications) of the device 705. The memory 730 may be a general-purpose storage component that stores code executable by the processor 740. Such code may include instructions that, when executed by the processor 740, cause the device 705 to perform various functions (such as to support an application of the device 705). The I/O controller 710 may manage inputs and outputs for the device 705, may manage peripherals not integrated into the device 705, or may represent a physical connection (such as port) to an external peripheral. The processor 740 may interact with a modem, a keyboard, a mouse, a touchscreen, or other device (such as via I/O controller 710). In some implementations, a user may interact with the device 705 via the I/O controller 710 or via hardware components controlled by the I/O controller 710.

The processing system 720 may be an example of a processing system 140 or a processing system 620. For example, the processing system 720 may include processor circuitry 745 and memory circuitry 750 that stores code, and may be configured to cause the device 705 to perform operations that support combining DCI for accurate payload decoding. Although the processing system 720 is illustrated as a separate component, which may involve a separate chip, chipset, or other module, in some implementations, one or more functions described with reference to the processing system 720 may be supported by or performed by a transceiver 715, antenna(s) 725, a processor 740, memory 730, or any combination thereof, such that a processing system 720 may include one or more of a transceiver 715, antenna(s) 725, a processor 740, memory 730, or any combination thereof.

By including or configuring the processing system 720 for operation in the device 705 as described herein, may support techniques for improved communication reliability, reduced blind decoding and DCI decoding latency, reduced power consumption due to fewer failed blind decoding attempts, more efficient utilization of communication resources, improved coordination between devices, longer battery life, improved accuracy for DCI decoding, and reduced control signaling overhead.

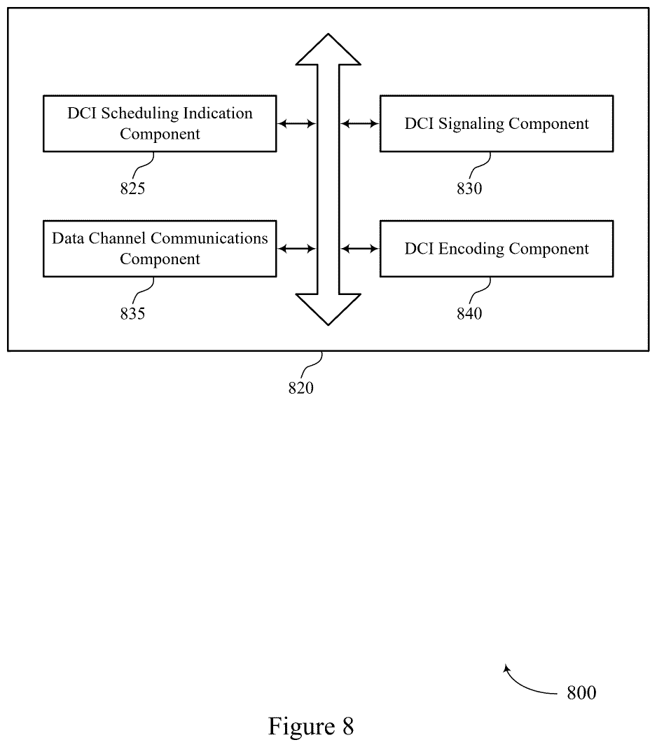

FIG. 8 shows an example 800 of a processing system 820 that supports combining DCI for accurate payload decoding. A processing system 820 may be an example of a processing system 145 (such as network entity 105) and may include a DCI scheduling indication component 825, a DCI signaling component 830, a data channel communications component 835, a DCI encoding component 840, or any combination thereof. A processing system 820, or various component thereof, may be an example of means for performing (such as a means for causing a network entity 105 to perform) various techniques described herein.

The DCI scheduling indication component 825 may be configured to cause the network entity 105 to output control signaling that indicates a set of resources allocated for one or more DCI messages including at least a first DCI message and a retransmission of the first DCI message, and mapping information indicating a second set of bit fields included within the retransmission of the first DCI message that are unchanged relative to a first set of bit fields included within the first DCI message as originally transmitted. The DCI signaling component 830 may be configured to cause the network entity 105 to output the first DCI message via the set of resources. In some examples, the DCI signaling component 830 may be configured to cause the network entity 105 to output, via the set of resources, the retransmission of the first DCI message that includes the second set of bit fields that are unchanged relative to the first set of bit fields included in the first DCI message. The data channel communications component 835 may be configured to cause the network entity 105 to communicate with a UE in accordance with a payload of the first DCI message and the retransmission of the first DCI message.

In some examples, the DCI encoding component 840 may be configured to cause the network entity 105 to encode the first DCI message and the retransmission of the first DCI message in accordance with a systematic encoding of the first set of bit fields and the second set of bit fields, where outputting the first DCI message and the retransmission of the first DCI message is based on the systematic encoding.

A processing system 820 may include or be an example of one or more chips, SoCs, chipsets, packages, components, or devices that individually or collectively constitute or include a processing system. A processing system 820 may interface with other components of a network entity 105. For example, operations described with reference to a processing system 820, or various components thereof, may be performed by or with other such components, including a receiver, a transmitter, a transceiver, a modem, a user interface, a modulator/demodulator, an encoder/decoder, or any combination thereof (such as of the processing system 820, coupled with the processing system 820, of a network entity 105). Operations described herein with reference to the processing system 820, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 820 for operation in a processing system 820 as described herein, the processing system 820 may support techniques for improved communication reliability, reduced blind decoding and DCI decoding latency, reduced power consumption due to fewer failed blind decoding attempts, more efficient utilization of communication resources, improved coordination between devices, longer battery life, improved accuracy for DCI decoding, and reduced control signaling overhead.

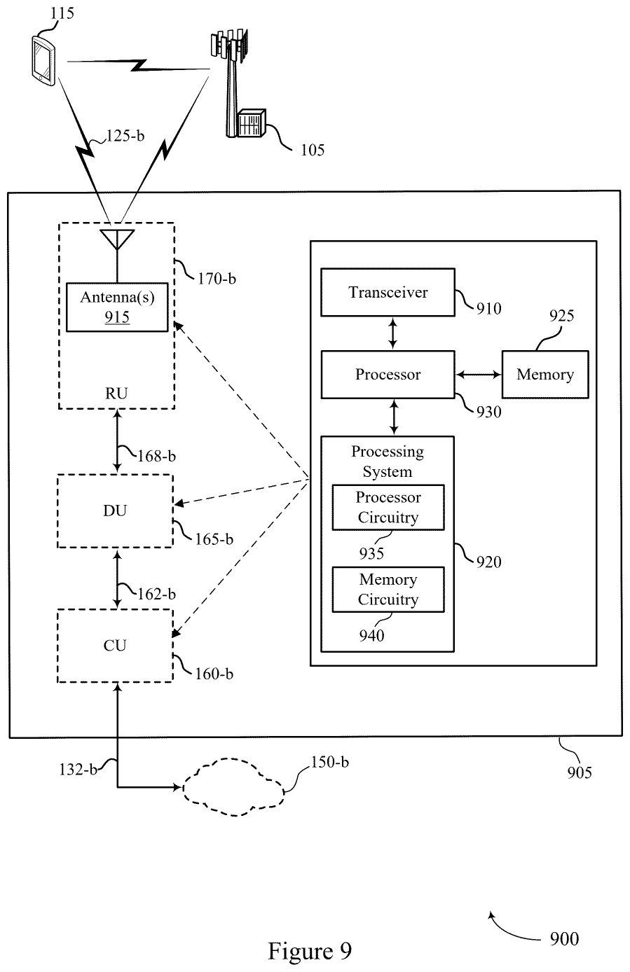

FIG. 9 shows an example of a system 900 including a device 905 that supports combining DCI for accurate payload decoding. The device 905 may communicate (such as via one or more wired interfaces or one or more wireless interfaces) with other network devices or network equipment such as a core network 150-b, other network entities 105, UEs 115, or any combination thereof. The device 905 may include components for transmitting and receiving communication, which may include a processing system 920, a transceiver 910, antenna(s) 915, a memory 925, and a processor 930. Components of the device 905 may be coupled (such as operatively, communicatively, functionally, electronically, electrically, in electronic communication) via one or more interfaces.

The transceiver 910 may communicate bi-directionally with another transceiver via wired or wireless links, and may support transmission operations, reception operations, or both, as described herein. The transceiver 910 may include a modem to modulate and demodulate signals, to provide the modulated signals for transmission (such as via antenna(s) 915, via a wired interface), and to demodulate received signals (such as received via antenna(s) 915, received via a wired interface). The transceiver 910 may be operable to support communication via one or more communication links (such as a communication link 125-b, a backhaul link 132-b, a midhaul link 162-b, fronthaul link 168-b).

The processor 930 may be a general-purpose processing component that supports various operations (such as applications) of the device 905. The memory 925 may be a general-purpose storage component that stores code executable by the processor 930. Such code may include instructions that, when executed by the processor 930, cause the device 905 to perform various functions (such as to support an application of the device 905).

For examples in which the device 905 is a network entity 105 in a disaggregated architecture, one or more components of the device 905 may be located at one or more of a CU 160-b, a DU 165-b, or an RU 170-b, one or more of which may include aspects of the processing system 920, the processor 930, the memory 925, or the transceiver 910. Functions of the device 905 may be performed at different components or an operation may be divided between different components (such as different functions being supported by aspects of the CU 160-b, the DU 165-b, or the RU 170-b, the transceiver 910, the processor 930, the memory 925, the processing system 920, or any combination thereof). For example, the processing system 920 may be a component of one or more of the CU 160-b, the DU 165-b, or the RU 170-b. In some examples, interfaces between components of device 905 (such as CU 160-b, DU 165-b, RU 170-b) may support communication at a protocol layer or between protocol layers of a protocol stack.

In some examples, the processing system 920 may manage aspects of communication with the core network 150-b (such as via a backhaul link 132). For example, the processing system 920 may manage the transfer of data communication for UEs 115 with a gateway of the core network 150-b. In some examples, the processing system 920 may manage communication with one or more other network entities 105 and may include a controller or scheduler for controlling communication with UEs 115 (such as in cooperation with the one or more other network entities 105). In some examples, the processing system 920 may support an interface (such as X2 interface, Xn interface) to provide communication between network entities 105.

The processing system 920 may be an example of a processing system 145 or a processing system 820. For example, the processing system 920 may include processor circuitry 935 and memory circuitry 940 that stores code, and the processing system 920 may be configured to cause the device 905 to perform operations that support combining DCI for accurate payload decoding. Although the processing system 920 is illustrated as a separate component, which may involve a separate chip, chipset, or other module, in some implementations, one or more functions described with reference to the processing system 920 may be supported by or performed by a transceiver 910, antenna(s) 915, a processor 930, memory 925, or any combination thereof, such that a processing system 920 may include one or more of a transceiver 910, antenna(s) 915, a processor 930, memory 925, or any combination thereof. Further, processor circuitry 935 and memory circuitry 940 each may be implemented at the device 905 in accordance with an aggregated architecture, or the processor circuitry 935 and the memory circuitry 940 may be implemented at one or more of a CU 160-b, a DU 165-b, or an RU 170-b in accordance with a disaggregated architecture.

By including or configuring the processing system 920 for operation in the device 905 as described herein, may support techniques for improved communication reliability, reduced blind decoding and DCI decoding latency, reduced power consumption due to fewer failed blind decoding attempts, more efficient utilization of communication resources, improved coordination between devices, longer battery life, improved accuracy for DCI decoding, and reduced control signaling overhead.

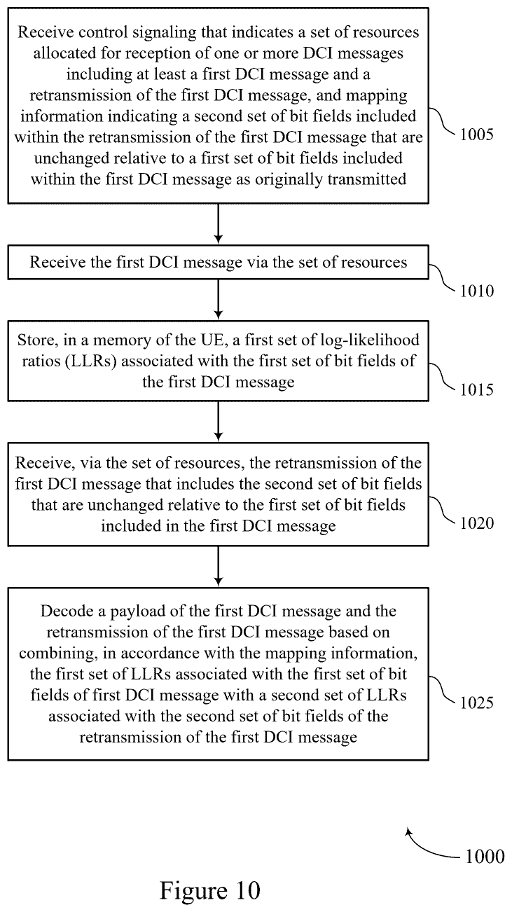

FIG. 10 shows an example of a method 1000 that supports combining DCI for accurate payload decoding. Operations of the method 1000 may be performed by a UE or its components (such as using a processing system configured to cause the UE 115 to perform one or more of the operations) as described herein.

At method step 1005, the method may include receiving control signaling that indicates a set of resources allocated for reception of one or more DCI messages including at least a first DCI message (e.g., the DCI 205, as described with reference to FIG. 2) and a retransmission of the first DCI message (e.g., the retransmission, as described with reference to FIG. 2), and mapping information indicating a second set of bit fields (e.g., the fourth field 320 and the second field 310 described with reference to FIG. 3) the included within the retransmission of the first DCI message that are unchanged relative to a first set of bit fields (e.g., the first field 305, the second field 310, the third field 315, and the fourth field 320, described with reference to FIG. 3) included within the first DCI message as originally transmitted. In some examples, aspects of the operations of 1005 may be performed by a DCI identification and reception component 625.

At method step 1010, the method may include receiving the first DCI message (e.g., the DCI 205) via the set of resources. In some examples, aspects of the operations of 1010 may be performed by a DCI identification and reception component 625.

At method step 1015, the method may include storing, in a memory of the UE, a first set of LLRs associated with the first set of bit fields (e.g., the first field 305, the second field 310, the third field 315, and the fourth field 320, described with reference to FIG. 3) of the first DCI message. In some examples, aspects of the operations of 1015 may be performed by an LLR combining component 630.

At method step 1020, the method may include receiving, via the set of resources, the retransmission of the first DCI message (e.g., the DCI retransmission 210) that includes the second set of bit fields that are unchanged relative to the first set of bit fields (e.g., the fourth field 320 and the second field 310 described with reference to FIG. 3) included in the first DCI message. In some examples, aspects of the operations of 1020 may be performed by a DCI identification and reception component 625.

At method step 1025, the method may include decoding a payload of the first DCI message (e.g., the DCI 205) and the retransmission of the first DCI message (e.g., the DCI retransmission 210) based on combining, in accordance with the mapping information, the first set of LLRs associated with the first set of bit fields of first DCI message with a second set of LLRs associated with the second set of bit fields of the retransmission of the first DCI message. In some examples, aspects of the operations of 1025 may be performed by an LLR combining component 630.

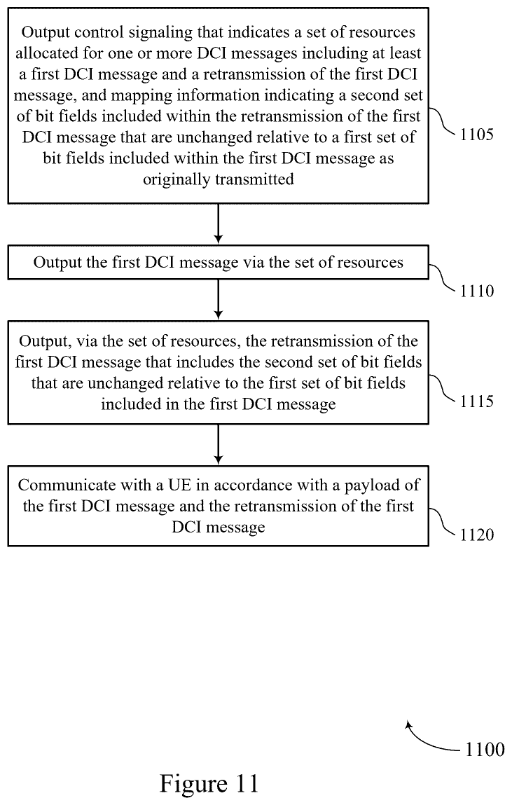

FIG. 11 shows an example of a method 1100 that supports combining DCI for accurate payload decoding. Operations of the method 1100 may be performed by a network entity 105 or its components (such as using a processing system configured to cause the network entity to perform one or more operations) as described herein.

At method step 1105, the method may include outputting control signaling that indicates a set of resources allocated for one or more DCI messages including at least a first DCI message (e.g., the DCI 205, as described with reference to FIG. 2) and a retransmission of the first DCI message (e.g., the retransmission, as described with reference to FIG. 2), and mapping information indicating a second set of bit fields (e.g., the fourth field 320 and the second field 310 described with reference to FIG. 3) included within the retransmission of the first DCI message that are unchanged relative to a first set of bit fields (e.g., the first field 305, the second field 310, the third field 315, and the fourth field 320, described with reference to FIG. 3) included within the first DCI message as originally transmitted. In some examples, aspects of the operations of 1105 may be performed by a DCI scheduling indication component 825.

At method step 1110, the method may include outputting the first DCI message (e.g., the DCI 205) via the set of resources. In some examples, aspects of the operations of 1110 may be performed by a DCI signaling component 830.

At method step 1115, the method may include outputting, via the set of resources, the retransmission of the first DCI message (e.g., the DCI retransmission 210) that includes the second set of bit fields (e.g., the fourth field 320 and the second field 310 described with reference to FIG. 3) that are unchanged relative to the first set of bit fields (e.g., the first field 305, the second field 310, the third field 315, and the fourth field 320, described with reference to FIG. 3) included in the first DCI message. In some examples, aspects of the operations of 1115 may be performed by a DCI signaling component 830.

At method step 1120, the method may include communicating with a UE in accordance with a payload of the first DCI message (e.g., the DCI 205) and the retransmission of the first DCI message (e.g., the DCI retransmission 210). In some examples, aspects of the operations of 1120 may be performed by a data channel communications component 835.

Implementation examples are described in the following numbered clauses:

Aspect 1: A method for wireless communications at a UE, comprising: receiving control signaling that indicates a set of resources allocated for reception of one or more DCI messages comprising at least a first DCI message and a retransmission of the first DCI message, and mapping information indicating a second set of bit fields included within the retransmission of the first DCI message that are unchanged relative to a first set of bit fields included within the first DCI message as originally transmitted;
receiving the first DCI message via the set of resources; storing, in a memory of the UE, a first set of LLRs associated with the first set of bit fields of the first DCI message;
receiving, via the set of resources, the retransmission of the first DCI message that includes the second set of bit fields that are unchanged relative to the first set of bit fields included in the first DCI message; and decoding a payload of the first DCI message and the retransmission of the first DCI message based at least in part on combining, in accordance with the mapping information, the first set of LLRs associated with the first set of bit fields of first DCI message with a second set of LLRs associated with the second set of bit fields of the retransmission of the first DCI message.

Aspect 2: The method of aspect 1, further comprising: receiving, via the control signaling, additional control signaling, or both, a timing relationship for receiving the retransmission of the first DCI message relative to the first DCI message in a same downlink channel allocation, wherein combining the first set of LLRs and the second set of LLRs is based at least in part on receiving the retransmission of the first DCI message in accordance with the timing relationship.

Aspect 3: The method of any of aspects 1 through 2, wherein the first DCI message includes a first DCI identifier and the retransmission of the first DCI message includes a second DCI identifier that is incremented relative to the first DCI identifier, combining the first set of LLRs and the second set of LLRs is based at least in part on the first DCI identifier and the second DCI identifier.

Aspect 4: The method of any of aspects 1 through 3, wherein the retransmission of the first DCI message includes a pointer to a resource allocation associated with transmission of the first DCI message, and combining the first set of LLRs with the second set of LLRs is based at least in part on the pointer.

Aspect 5: The method of any of aspects 1 through 4, wherein the control signaling that indicates the set of resources allocated for reception of the first DCI message includes a pointer to a resource allocation associated with the retransmission of the first DCI message.

Aspect 6: The method of any of aspects 1 through 5, further comprising: transmitting one or more UE capability messages comprising an indication that the UE supports LLR combining, an indication of storage capabilities at the UE, an indication of whether the UE supports systematic polar decoding, or any combination thereof, wherein receiving the control signaling is based at least in part on transmitting the one or more UE capability messages.

Aspect 7: The method of aspect 6, wherein the storage capabilities of the UE comprise an indication of a quantity of LLRs the UE is capable of storing, an amount of information included in a quantity of slots that the UE is capable of storing, a quantity of DCIs for which the UE is able to store LLRs, a quantity of control channel elements (CCEs) for which the UE is able to store LLRs, or any combination thereof.

Aspect 8: The method of any of aspects 1 through 7, further comprising: transmitting, to a network entity, an indication of a failure to decode the first DCI message, wherein receiving the retransmission of the first DCI message is based at least in part on transmitting the indication of the failure.

Aspect 9: The method of any of aspects 1 through 8, wherein the retransmission of the first DCI message comprises a third set of bit fields that are changed relative to corresponding bit fields of the first DCI message, the third set of bit fields including one or more indicator fields that are either incremented relative to corresponding indicator fields of the first DCI message or indicated as being unchanged relative to the corresponding indicator fields of the first DCI message, the UE refrains from combining LLRs associated with the one or more indicator fields based at least in part on the third set of bit fields being changed or being indicated as being unchanged relative to corresponding bit fields of the first DCI message.

Aspect 10: The method of aspect 9, wherein the one or more indicator fields comprise at least one of a downlink assignment index (DAI) field, a null data indicator (NDI) field, a frequency domain resource allocation (FDRA) field, or a time domain resource allocation (TDRA) field.

Aspect 11: The method of any of aspects 1 through 10, wherein the first DCI message and the retransmission of the first DCI message are encoded in accordance with a systematic encoding of the first set of bit fields and the second set of bit fields.

Aspect 12: The method of aspect 11, wherein the first set of bit fields of the first DCI message comprise at least a subset of the payload of the first DCI message, the second set of bit fields comprise at least a subset of the payload of the retransmission of the first DCI message, and the first DCI message and the retransmission of the first DCI message are included in different quantities of control channel elements and are associated with different downlink control channel allocations.

Aspect 13: The method of any of aspects 11 through 12, wherein the systematic encoding comprises a systematic polar encoding.

Aspect 14: The method of any of aspects 1 through 13, wherein the first DCI message is received in accordance with a first aggregation level configuration associated with a first quantity of control channel elements (CCEs) of a first set of resource element groups (REGs) for conveying the first DCI message, and the retransmission of the first DCI message is received in accordance with a second aggregation level configuration that corresponds to one or more repetitions of the first aggregation level configuration, the second aggregation level configuration associated with a second quantity of CCEs of a second set of REGs for conveying the retransmission of the first DCI message.

Aspect 15: The method of aspect 14, further comprising: combining the first set of LLRs corresponding to the first set of CCEs associated with the first aggregation level configuration of the first DCI message with the second set of LLRs corresponding to the second set of CCEs associated with the second aggregation level configuration of the retransmission of the first DCI message.

Aspect 16: The method of any of aspects 1 through 15, further comprising: transmitting an indication of a DCI detection type supported for LLR combining, wherein decoding the payload is based at least in part on the first DCI message and the retransmission of the first DCI message comprising the DCI detection type, and wherein the DCI detection type comprises a non-blind decoded DCI, a DCI candidate located in a common search space, a DCI candidate located in a UE-specific search space, or any combination thereof.

Aspect 17: The method of any of aspects 1 through 16, wherein the control signaling comprises one or more RRC messages, one or more medium access control-control elements (MAC-CEs), or both.

Aspect 18: The method of any of aspects 1 through 17, wherein the mapping information comprises a bitmap that indicates, using respective binary values, individual bits included in the second set of bit fields that are changed or unchanged relative to the first set of bit fields, or an indication that the first set of bit fields and the second set of bit fields include a set of unchanged bit values for both the first DCI message and the retransmission of the first DCI message.

Aspect 19: The method of any of aspects 1 through 18, wherein the first set of LLRs and the second set of LLRs comprise a matching set of LLRs, and the second set of bit fields included within the retransmission of the first DCI message include a second set of bits that are unchanged relative to a first set of bits of the first set of bit fields included within the first DCI message as originally transmitted.

Aspect 20: A method for wireless communications at a network entity, comprising: outputting control signaling that indicates a set of resources allocated for one or more DCI messages comprising at least a first DCI message and a retransmission of the first DCI message, and mapping information indicating a second set of bit fields included within the retransmission of the first DCI message that are unchanged relative to a first set of bit fields included within the first DCI message as originally transmitted; outputting the first DCI message via the set of resources; outputting, via the set of resources, the retransmission of the first DCI message that includes the second set of bit fields that are unchanged relative to the first set of bit fields included in the first DCI message; and communicating with a UE in accordance with a payload of the first DCI message and the retransmission of the first DCI message.

Aspect 21: The method of aspect 20, further comprising: encoding the first DCI message and the retransmission of the first DCI message in accordance with a systematic encoding of the first set of bit fields and the second set of bit fields, wherein outputting the first DCI message and the retransmission of the first DCI message is based at least in part on the systematic encoding.

Aspect 22: A UE for wireless communications, comprising a processing system that includes processor circuitry and memory circuitry that stores code, the processing system configured to cause the UE to perform a method of any of aspects 1 through 19.

Aspect 23: A UE for wireless communications, comprising at least one means for performing a method of any of aspects 1 through 19.

Aspect 24: A non-transitory computer-readable medium storing code for wireless communications, the code comprising instructions executable by one or more processors to perform a method of any of aspects 1 through 19.

Aspect 25: A network entity for wireless communications, comprising a processing system that includes processor circuitry and memory circuitry that stores code, the processing system configured to cause the network entity to perform a method of any of aspects 20 through 21.

Aspect 26: A network entity for wireless communications, comprising at least one means for performing a method of any of aspects 20 through 21.

Aspect 27: A non-transitory computer-readable medium storing code for wireless communications, the code comprising instructions executable by one or more processors to perform a method of any of aspects 20 through 21.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
receive control signaling that indicates a set of resources allocated for reception of one or more downlink control information (DCI) messages comprising at least a first DCI message and a retransmission of the first DCI message, and mapping information indicating a second set of bit fields included within the retransmission of the first DCI message that are unchanged relative to a first set of bit fields included within the first DCI message as originally transmitted;
receive the first DCI message via the set of resources;
store, in a memory of the UE, a first set of log-likelihood ratios (LLRs) associated with the first set of bit fields of the first DCI message;
receive, via the set of resources, the retransmission of the first DCI message that includes the second set of bit fields that are unchanged relative to the first set of bit fields included in the first DCI message; and
decode a payload of the first DCI message and the retransmission of the first DCI message based at least in part on combining, in accordance with the mapping information, the first set of LLRs associated with the first set of bit fields of the first DCI message with a second set of LLRs associated with the second set of bit fields of the retransmission of the first DCI message.

2. The UE of claim 1, wherein the processing system is further configured to cause the UE to:
receive, via the control signaling or additional control signaling, a timing relationship for receiving the retransmission of the first DCI message relative to the first DCI message in a same downlink channel allocation, wherein combining the first set of LLRs and the second set of LLRs is based at least in part on receiving the retransmission of the first DCI message in accordance with the timing relationship.

3. The UE of claim 1, wherein the first DCI message includes a first DCI identifier and the retransmission of the first DCI message includes a second DCI identifier that is incremented relative to the first DCI identifier, and wherein combining the first set of LLRs and the second set of LLRs is based at least in part on the first DCI identifier and the second DCI identifier.

4. The UE of claim 1, wherein the retransmission of the first DCI message includes a pointer to a resource allocation associated with transmission of the first DCI message, and wherein combining the first set of LLRs with the second set of LLRs is based at least in part on the pointer.

5. The UE of claim 1, wherein the control signaling that indicates the set of resources allocated for reception of the first DCI message includes a pointer to a resource allocation associated with the retransmission of the first DCI message.

6. The UE of claim 1, wherein the processing system is further configured to cause the UE to:
transmit one or more UE capability messages comprising an indication that the UE supports LLR combining, an indication of storage capabilities at the UE, an indication of whether the UE supports systematic polar decoding, or any combination thereof, wherein receiving the control signaling is based at least in part on transmitting the one or more UE capability messages.

7. The UE of claim 6, wherein the storage capabilities of the UE comprise an indication of a quantity of LLRs the UE is capable of storing, an amount of information included in a quantity of slots that the UE is capable of storing, a quantity of DCIs for which the UE is able to store LLRs, a quantity of control channel elements (CCEs) for which the UE is able to store LLRs, or any combination thereof.

8. The UE of claim 1, wherein the processing system is further configured to cause the UE to:
transmit, to a network entity, an indication of a failure to decode the first DCI message, wherein receiving the retransmission of the first DCI message is based at least in part on transmitting the indication of the failure.

9. The UE of claim 1, wherein the retransmission of the first DCI message comprises a third set of bit fields that are changed relative to corresponding bit fields of the first DCI message, the third set of bit fields including one or more indicator fields that are either incremented relative to corresponding indicator fields of the first DCI message or indicated as being unchanged relative to the corresponding indicator fields of the first DCI message, wherein the UE refrains from combining LLRs associated with the one or more indicator fields based at least in part on the third set of bit fields being changed or being indicated as being unchanged relative to corresponding bit fields of the first DCI message.

10. The UE of claim 9, wherein the one or more indicator fields comprise at least one of a downlink assignment index (DAI) field, a null data indicator (NDI) field, a frequency domain resource allocation (FDRA) field, or a time domain resource allocation (TDRA) field.

11. The UE of claim 1, wherein the first DCI message and the retransmission of the first DCI message are encoded in accordance with a systematic encoding or a systematic polar encoding of the first set of bit fields and the second set of bit fields.

12. The UE of claim 11, wherein:
the first set of bit fields of the first DCI message comprise at least a subset of the payload of the first DCI message,
the second set of bit fields comprise at least a subset of the payload of the retransmission of the first DCI message, and
the first DCI message and the retransmission of the first DCI message are included in different quantities of control channel elements and are associated with different downlink control channel allocations.

13. The UE of claim 1, wherein:
the first DCI message is received in accordance with a first aggregation level configuration associated with a first quantity of control channel elements (CCEs) of a first set of resource element groups (REGs) for conveying the first DCI message, and
the retransmission of the first DCI message is received in accordance with a second aggregation level configuration that corresponds to one or more repetitions of the first aggregation level configuration, the second aggregation level configuration associated with a second quantity of CCEs of a second set of REGs for conveying the retransmission of the first DCI message.

14. The UE of claim 13, wherein the processing system is further configured to cause the UE to:
combine the first set of LLRs corresponding to the first set of CCEs associated with the first aggregation level configuration of the first DCI message with the second set of LLRs corresponding to the second quantity of CCEs associated with the second aggregation level configuration of the retransmission of the first DCI message.

15. The UE of claim 1, wherein the processing system is further configured to cause the UE to:
transmit an indication of a DCI detection type supported for LLR combining, wherein decoding the payload is based at least in part on the first DCI message and the retransmission of the first DCI message comprising the DCI detection type, and wherein the DCI detection type comprises a non-blind decoded DCI, a DCI candidate located in a common search space, a DCI candidate located in a UE-specific search space, or any combination thereof.

16. The UE of claim 1, wherein the mapping information comprises:
a bitmap that indicates, using respective binary values, individual bits included in the second set of bit fields that are changed or unchanged relative to the first set of bit fields, or
an indication that the first set of bit fields and the second set of bit fields include a set of unchanged bit values for both the first DCI message and the retransmission of the first DCI message.

17. The UE of claim 1, wherein:
the first set of LLRs and the second set of LLRs comprise a matching set of LLRs, and
the second set of bit fields included within the retransmission of the first DCI message include a second set of bits that are unchanged relative to a first set of bits of the first set of bit fields included within the first DCI message as originally transmitted.

18. A network entity, comprising:
a processing system that includes processor circuitry and memory circuitry that stores code, the processing system configured to cause the network entity to:
output control signaling that indicates a set of resources allocated for one or more downlink control information (DCI) messages comprising at least a first DCI message and a retransmission of the first DCI message, and mapping information indicating a second set of bit fields included within the retransmission of the first DCI message that are unchanged relative to a first set of bit fields included within the first DCI message as originally transmitted;
output the first DCI message via the set of resources;
output, via the set of resources, the retransmission of the first DCI message that includes the second set of bit fields that are unchanged relative to the first set of bit fields included in the first DCI message; and
communicate with a user equipment (UE) in accordance with a payload of the first DCI message and the retransmission of the first DCI message.

19. The network entity of claim 18, wherein the processing system is further configured to cause the network entity to:
encode the first DCI message and the retransmission of the first DCI message in accordance with a systematic encoding of the first set of bit fields and the second set of bit fields, wherein outputting the first DCI message and the retransmission of the first DCI message is based at least in part on the systematic encoding.

20. A method for wireless communications at a user equipment (UE), comprising:
receiving control signaling that indicates a set of resources allocated for reception of one or more downlink control information (DCI) messages comprising at least a first DCI message and a retransmission of the first DCI message, and mapping information indicating a second set of bit fields included within the retransmission of the first DCI message that are unchanged relative to a first set of bit fields included within the first DCI message as originally transmitted;
receiving the first DCI message via the set of resources;
storing, in a memory of the UE, a first set of log-likelihood ratios (LLRs) associated with the first set of bit fields of the first DCI message;
receiving, via the set of resources, the retransmission of the first DCI message that includes the second set of bit fields that are unchanged relative to the first set of bit fields included in the first DCI message; and
decoding a payload of the first DCI message and the retransmission of the first DCI message based at least in part on combining, in accordance with the mapping information, the first set of LLRs associated with the first set of bit fields of the first DCI message with a second set of LLRs associated with the second set of bit fields of the retransmission of the first DCI message.
